(19) United States
(12) Patent Application Publication
(10) Pub. No.: US 2015/0110077 A1
(43) Pub. Date: Apr. 23, 2015

(54) METHOD AND APPARATUS FOR CAUSING INFORMATION RELATED TO MUTUAL COMMUNICATION PROPERTY BETWEEN A TERMINAL AND ACCESS POINTS OF A WIRELESS NETWORK TO BE USED IN CONNECTING TO THE WIRELESS NETWORK

(71) Applicant: AIRPLUG INC., Seoul (KR)

(72) Inventors: Seung Jun Lee, Seoul (KR); Sang Kug Yi, Gwangju-si (KR); Jun Seok Song, Seoul (KR)

(73) Assignee: AIRPLUG INC., Seoul (KR)

(21) Appl. No.: 14/389,996

(22) PCT Filed: Mar. 20, 2013
(86) PCT No.: PCT/KR2013/002306

§ 371 Date: Oct. 1, 2014

(30) Foreign Application Priority Data
Apr. 20, 2012 (KR) 10-2012-0041750

(51) Int. Cl. H04W 36/30; H04W 24/08; H04W 48/20

(52) U.S. Cl. CPC H04W 36/30; H04W 48/20; H04W 24/08
USPC 370/332

(57) ABSTRACT

A wireless communication terminal according to the present invention determines signal strength value of a particular property based on a data reception speed at the time of using a data service through an arbitrary AP (Access Point) of a wireless data network and prepares mutual communication property information including identification information of the arbitrary AP and type information (for example, model number) of the wireless communication terminal in addition to the determined value and reports the prepared mutual communication property information to a remote server.

### TECHNICAL FIELD

The present invention is related to a method and an apparatus enabling a wireless communication terminal to access a wireless data network by using connection supporting information determined from property information obtained through a data service provided from the wireless data network such as a Wi-Fi network.

### BACKGROUND ART

As mobile communication networks are advanced, users are now able to enjoy various kinds of information and contents for their needs through data services provided by the mobile communication networks regardless of their current location by using a wireless communication terminal such as a smart phone, tablet computer, and the like, not to mention a mobile phone.

In the case of information or contents containing a large amount of data, users tend to access the information or contents by accessing a high-speed wireless data network, for example, Wi-Fi wireless LAN (hereinafter, it is called “Wi-Fi network” for short); in other cases, the users tend to use a data service, for example, from a cellular mobile communication network. This tendency results from a current situation that a high-speed wireless data network provides the users with a communication infrastructure free of charge but available only in a relatively narrow area.

Therefore, from the user's point of view, unavailability of a high-speed wireless data network in the space frequently visited by the user can immediately lead to a complaint about a mobile communication service provider. On the other hand, since quality of an essential service, which is a voice communication service, is degraded as a load on a mobile communication network due to data services is increased, it is advantageous for the mobile communication service provider to use a high-speed wireless data network for the data services wherever possible.

Taking account of user responses to the communication services and conditions thereof, mobile communication service providers install access points (APs) to a high-speed wireless data network such as a Wi-Fi network for those places populated by users, thus attempting to direct data services of users to the Wi-Fi network.

Accordingly, a wireless communication terminal carried by a user, if it is ready to access a Wi-Fi network and connection to the Wi-Fi network is activated, attempts automatic connection to an AP of the corresponding communication network that has a service set identifier (SSID) known from previous connection to the network. Similarly, according to the user's request, service identification information of APs and received signal strength are combined in the form of set and displayed on a screen; if the user selects one from the displayed list, the terminal attempts connection to the AP corresponding to the selected item.

However, such an attempt does not always guarantee connection to the corresponding communication network. Depending on a situation, the connection attempt may lead to succession of failures. This is because attempts of a wireless communication terminal may be made without considering the corresponding access point and mutual communication properties between the corresponding AP and wireless terminal. For example, it may be the case that signal strength of a signal currently being received is not enough for successful connection; aside from the signal strength required for connection establishment, signal strength may still be required to be higher than the strength of the receive signal due to physical communication properties between a wireless communication terminal of the corresponding type and the access point.

In such a situation, a wireless communication terminal continuously attempts to establish connection within the coverage area of the corresponding access point, which eventually accelerates battery consumption of the wireless communication terminal and acts as unnecessary waiting time for the user trying to connect to a Wi-Fi network on purpose.

### DISCLOSURE

### Problem to be Solved

One objective of the present invention is to provide a method and an apparatus for providing reference information determined based on mutual communication property information for a wireless communication terminal to select the best access point in terms of communication property between the terminal and an access point of a wireless communication network.

Another objective of the present invention is to provide a method and an apparatus for a wireless communication terminal to select an access point of a wireless communication network that can provide the highest quality data service in a probabilistic sense for the type of the corresponding terminal based on statistical data.

Yet another objective of the present invention is to provide a method and an apparatus for collecting mutual communication property information and using the collected information for selection of an access point so that a wireless communication terminal can select the best access point by taking account of communication property between the terminal and access points of a wireless communication network.

Still another objective of the present invention is to provide a method and an apparatus for allowing optimal selection of an access point in a current situation by compensating mutual communication property information by taking account of current communication conditions of the surroundings.

Further objective of the present invention is to provide a method and an apparatus for improving accuracy or reliability of mutual communication property information by collecting for each wireless communication terminal data service properties when an access point of a wireless communication network is used and classifying the properties according to the type of the wireless communication terminal and the access point and utilizing them statistically.

The scope of the present invention is not necessarily limited to the above explicit statements. Rather, the scope of the present invention covers anything to accomplish effects that could be derived from the below specific and illustrative explanations of the present invention.

### Technical Solution

A wireless communication terminal capable of accessing a plurality of heterogeneous networks according to one aspect of the present invention, comprises: an information reporting unit configured to determine a value of a first property signal strength based on data receiving speed during usage of a data service through an arbitrary access point of the wireless data network, prepare mutual communication property information including at least the determined value or at least a third value determined from the determined value and a value of a second property signal strength, the mutual communication property information further including identification information of the arbitrary access point and type information of the wireless communication terminal, and report the mutual communication property information to a remote server through one network among the plurality of heterogeneous networks; and an access point selecting unit configured to receive from a remote server reference information containing one or more reference values regarding at least one access point by transmitting a request for access point reference information through one network among the plurality of heterogeneous networks, the request including type information of the wireless communication terminal and identification information of one or more access points belonging to the wireless data network, calculate, for each of one or more access points found from searching the wireless data network, relative strength of a signal strength of the each access point with respect to a reference value of the each access point written in the received reference information, and determine whether to switch to the wireless data network or connection priority of the found access points, based on the calculated relative strengths.

In an embodiment of the present invention, the information reporting unit is configured to determine a particular value as the value of the first property signal strength, the particular value being a value of a smallest signal strength at which receiving speeds pertaining to upper part of a predetermined ratio or all in a distribution of receiving speeds have been provided, and the distribution consisting of receiving speeds that are equal to or above a predetermined speed among receiving speeds obtained from measuring receiving speed of the wireless communication terminal for data received through the arbitrary access point.

In an embodiment of the present invention, the value of the second property signal strength is smaller than the value of the first property signal strength, and the third value is determined according to a pre-specified method between the value of the first property signal strength and the value of the second property signal strength. In this embodiment, the value of the second property signal strength may be a signal strength value that is detected at time of successful connection in a case that a connection process carried out for the arbitrary access point satisfies a pre-specified condition. In another embodiment, the information reporting unit may be further configured to determine the value of the second property signal strength only in a case that a requested transmission speed for a data object requested to an external server by another entity being executed in the wireless communication terminal is detected, wherein the value of the second property signal strength is a value of highest signal strength at which all or a part of receiving speeds, which are equal to or below a predetermined speed among receiving speeds obtained from measuring receiving speed of the wireless communication terminal for data received through the arbitrary access point, have been provided.

In an embodiment of the present invention, the information reporting unit is configured to prepare the mutual communication property information to further incorporate therein an indicator which enables to determine whether a value of the first property signal strength is included or whether the third value is included in the mutual communication property information.

In an embodiment of the present invention, the information reporting unit is configured to prepare the mutual communication property information by further incorporate therein information about date and time at which a signal strength value included in the mutual communication property information is obtained.

In an embodiment of the present invention, the information reporting unit is configured to further incorporate, with respect to at least one access point other than the arbitrary access point, a value of the first property signal strength or a third value determined from the value of the first property signal strength and a value of the second property signal strength in the mutual communication property information together with identification information of each of the at least one access point.

In an embodiment of the present invention, in a case that an access point to which the calculated relative strength is related uses a channel overlapping with another access point, the access point selecting unit is further configured to modify the relative strength to be decreased and use the modified relative strength in the determination of the connection priority. In this embodiment, the access point selecting unit may be configured to determine an amount of the modification of relative strength according to how many access points are overlapped in a channel or signal strength of another access point having an overlapping channel.

In an embodiment of the present invention, the signal strength of the each access point can be a signal strength detected from searching the wireless data network for access points before or after receiving the reference information.

In an embodiment of the present invention, the access point selecting unit is configured to check whether a current state of the wireless communication terminal corresponds to a predetermined condition, and transmit the request for access point reference information if the current state corresponds to the predetermined condition, wherein the predetermined condition may be a condition that locking state of the wireless communication terminal is released, a condition that a search is to be made according to a predetermined search period, a condition that a pre-designated application starts up, a condition that a network access request is to be made from an arbitrary application, a condition that a request for entering the wireless data network is made from an external server, or a condition that higher bandwidth than a predetermined level is demanded for data to be received.

In an embodiment of the present invention, in a case that the connection priority of the found access points is determined, the access point selecting unit is further configured to request connection to an access point according to the determined priority.

A method of reporting property information on an access point according to another aspect of the present invention, comprises: checking a data receiving speed provided by an access point of a wireless data network and a signal strength from the access point repeatedly; determining a property value from signal strengths obtained from the repeatedly checking, based on a distribution of at least a part of the data receiving speeds obtained from the repeatedly checking; preparing mutual communication property information including the determined property value, identification information of the access point, and type information of the wireless communication terminal; and reporting the prepared mutual communication property information to the remote server of which address information for access is pre-assigned.

In an embodiment of the present invention, the property value corresponds to a smallest signal strength at which receiving speeds pertaining to upper part of a predetermined ratio or all in the distribution of a group of receiving speeds have been provided, the group consisting of receiving speeds that are equal to or above a predetermined speed among the data receiving speeds. In this embodiment, in the preparing, the mutual communication property information is prepared to further include a value corresponding to a signal strength detected at time of successful connection in a case that a connection process carried out previously for the access point satisfies a pre-specified condition. In another embodiment, in the preparing, the mutual communication property information is prepared to further include a value corresponding to a highest signal strength at which all or a part of receiving speeds, which are equal to or below a predetermined speed among data receiving speeds serviced by the access point and are also equal to or below a particular speed for receiving a data object requested by an arbitrary executable entity of the wireless communication terminal, have been provided.

In another embodiment of the present invention, the property value is a value, between a first value and a second value, obtained by applying the first value and the second value to a pre-specified rule, wherein the first value corresponds to a smallest signal strength at which receiving speeds pertaining to upper part of a predetermined ratio or all in the distribution of a group of receiving speeds have been provided, the group consisting of receiving speeds that are equal to or above a predetermined speed among the data receiving speeds, and the second value corresponds to a signal strength detected at time of successful connection in a case that a connection process carried out previously for the access point satisfies a pre-specified condition.

In another embodiment of the present invention, the property value is a value, between the first value and a third value, obtained by applying the first value and the third value to a pre-specified rule, wherein the third value corresponds to a highest signal strength at which all or a part of receiving speeds, which are equal to or below a predetermined speed among data receiving speeds serviced by the access point and are equal to or below a particular speed for receiving a data object requested by an arbitrary executable entity of the wireless communication, have been provided.

A method of using reference information for connecting to a wireless data network according to still another embodiment of the present invention, comprises: preparing a reference information request including type information of the wireless communication terminal and identification information of one or more access points found from a search of the wireless data network for access points; transmitting the prepared reference information request to the remote server of which address information for access is pre-assigned; receiving from the remote server reference information which is a response to the transmitted reference information request; calculating, for each of at least one access point found from searching the wireless data network, relative strength of a signal strength of the each access point with respect to a reference value of the each access point written in the received reference information; and determining whether to switch connection to the wireless data network or connection priority of the found access points, based on the calculated, individual relative strengths.

A wireless communication terminal capable of accessing a plurality of heterogeneous networks according to still another aspect of the present invention, comprises: an information collecting unit configured to determine a value of a first property signal strength and a value of a second property signal strength smaller than the value of the first property signal strength, based on a communication property related to an arbitrary access point of the wireless data network, prepare a property statistical table to reflect the determined values and identification information of the arbitrary access point, and determine, for each of at least one access point found from searching the wireless data network, a reference value from target statistical elements registered with respect to the each access point in the property statistical table; and an access point selecting unit configured to calculate, for each of the at least one access point, relative strength of a signal strength of the each access point with respect to the reference value determined by the information collecting unit for the each access point, and determine whether to switch connection from a currently connected wireless communication network to the wireless data network or connection priority of each of the at least one access point, based on the calculated relative strengths. In addition, in preparing the property statistical table to reflect the determined two values, the information collecting unit registers the two values in the property statistical table or registers a value, between the two values, obtained by applying the two values to a pre-specified rule.

In an embodiment of the present invention, in a case that any one of the found access points is an unregistered access point, the information collection unit is further configured to determine a reference value for the unregistered access point from a reference value obtained with respect to one or more access points, other than the unregistered access point, for which target statistical elements are listed in the property statistical table. In this embodiment, the information collecting unit is configured to choose the one or more access points based on number of target statistical elements listed in the property statistical table or how recent registration date and time is. Alternately, the information collecting unit may be configured to apply an average value or a weighted average value of reference values obtained with respect to the one or more access points as the reference value for the unregistered access point.

In another embodiment of the present invention, in a case that any one of the found access points is an unregistered access point, the information collecting unit is further configured to determine a particular property value as a reference value for the unregistered access point, the particular property value being determined from the values of the first and second property signal strengths obtained from measurement of a plurality of access points. In the present embodiment, the information collecting unit may be further configured to divide the access points of the wireless data network into a plurality of groups, and set a property value to be applied for an arbitrary unregistered access point belonging to each of the plurality of groups, the property value for the each group being determined from values of the first and second signal strengths obtained from measurement of access points pertaining to the each group.

In an embodiment of the present invention, the information collecting unit is configured to: determine a first particular value as the value of the first property signal strength, the first particular being a value of a smallest signal strength at which receiving speeds pertaining to upper part of a predetermined ratio or all in a distribution of receiving speeds have been provided, and the distribution consisting of receiving speeds that are equal to or above a predetermined speed among receiving speeds obtained from measuring data receiving speed of the wireless communication terminal for data received through the arbitrary access point; and determine a second particular value to the value of the second property signal strength, the second particular value being a value of a highest signal strength at which all or a part of receiving speeds, which are equal to or below a predetermined speed among receiving speeds obtained from measuring data receiving speed of the wireless communication terminal for data received through the arbitrary access point and are also equal to or below a particular speed for receiving a data object requested by an arbitrary executable entity of the wireless communication terminal, have been provided.

In another embodiment of the present invention, the information collecting unit may be configured to determine a particular value as the value of the second property signal strength, the particular value being a value that is detected at time of successful connection in a case that a connection process carried out for the arbitrary access point satisfies a pre-specified condition.

An apparatus equipped with a storage storing for programs according to still another aspect of the present invention, comprises: communication means being capable of transceiving data through communication with an outside entity; and storing means storing an application to be run on a wireless communication terminal, the application being transmitted or received through the communication means, wherein the application includes program codes to accomplish functions, in case of being run on the wireless communication terminal, that comprise: determining a value of a first property signal strength based on data receiving speed during usage of a data service through an access point of a wireless data network; preparing mutual communication property information including at least the determined value or at least a third value determined from the determined value and a value of a second property signal strength, the mutual communication property information further including identification information of the access point and type information of the wireless communication terminal; reporting the mutual communication property information to a remote server through one network among a plurality of heterogeneous networks; receiving from a remote server reference information containing one or more reference values regarding at least one access point by transmitting a request for access point reference information through one network among the plurality of heterogeneous networks, the request including type information of the wireless communication terminal and identification information of one or more access points belonging to the wireless data network; calculating, for each of one or more access points found from searching the wireless data network, relative strength of a signal strength of the each access point with respect to a reference value of the each access point written in the received reference information; and determining whether to switch to the wireless data network or connection priority of the found access points, based on the calculated relative strengths.

In accordance with still another aspect of the present invention, another application stored in storing means of an apparatus for providing programs through a network, may include program codes to accomplish functions, in case of being run on the wireless communication terminal, that comprise: a first function of determining a value of a first property signal strength and a value of a second property signal strength smaller than the value of the first property signal strength, based on a communication property related to an arbitrary access point of a wireless data network, and preparing a property statistical table to reflect the determined values and identification information of the arbitrary access point; a second function of determining, for each of at least one access point found from searching the wireless data network, a reference value from target statistical elements registered with respect to the each access point in the property statistical table; and a third function of calculating, for each of the at least one access point, relative strength of a signal strength of the each access point with respect to the reference value determined by the second function for the each access point, and determining whether to switch connection from a currently connected wireless communication network to the wireless data network or connection priority of each of the at least one access point, based on the calculated relative strengths, wherein in preparing the property statistical table to reflect the determined two values, the first function registers the two values in the property statistical table or registers a value, between the two values, obtained by applying the two values to a pre-specified rule.

A method for providing reference information for connecting to a wireless data network according to still another aspect of the present invention, comprises: causing a property statistical table to reflect received mutual communication property information, the mutual communication property information including, for at least one access point, a value of a first property signal strength determined based on a data receiving speed provided in using data service by each of the at least one access point, identification information of each of the at least one access point, and type information of a wireless communication terminal; obtaining a reference value from target statistical elements registered in the property statistical table, for each of one or more access points, if receiving from a particular wireless communication terminal a request of access point reference information in which access point identification information is specified for said one or more access points and type information of the particular wireless communication terminal is included, the obtained reference value being smaller than an average of values of the first property signal strength belonging to the target statistical elements that relate to the each access point and the type information of the particular wireless communication terminal; and preparing reference information by incorporating therein the reference value obtained for each of said one or more access points and transmitting the prepared reference information to the particular wireless communication.

In an embodiment of the present invention, the mutual communication property information further includes, for at least one access point, a value of a second property signal strength smaller than the value of the first signal strength. In this embodiment, the obtaining the reference value comprises: determining a first representative value from values of the first property signal strength belonging to the target statistical elements and a second representative value from values of the second property signal strength belonging to the target statistical elements; and deciding the reference value between the two representative values based on the first and second representative values.

In another embodiment of the present invention, the causing the property statistical table to reflect the mutual communication property information comprises: obtaining, based on a signal strength value different from the value of the first property signal strength, a value of a third property signal strength that is between the signal strength value and the value of the first property signal strength; and causing the property statistical table to reflect the obtained value of the third property signal strength instead of the value of the first property signal strength. In this embodiment, the obtaining the reference value obtains the reference value from a representative value determined from values of the third property signal strength belonging to the target statistical elements. In addition, the different signal strength value may be either a value of a second property signal strength smaller than the value of the first property signal strength or a predetermined value corresponding to the second property signal strength with respect to the type information of the wireless communication terminal and a corresponding access point that are specified in the mutual communication property information.

In an embodiment of the present invention, the causing the property statistical table to reflect the mutual communication property information comprises: determining one classifying item among predetermined classifying items based on date and time at which the value of the first property signal strength is obtained or at which the mutual communication property information is received; and causing the property statistical table to reflect the mutual communication property information in such a way that the mutual communication property information is classified into the property statistical table by the determined classifying item, wherein the obtaining the reference value comprises: determining one classifying item among predetermined classifying items based on date and time at which the request of access point reference information is received; and obtaining the reference value from statistical elements belonging to the determined classifying item among the target statistical elements.

In an embodiment of the present invention, the obtaining the reference value further obtains, for at least one additional access point besides said one or more access points specified in the request, a reference value from target statistical elements for the at least one additional access point and type information of the particular wireless communication terminal, the reference value being smaller than an average of values of the first property signal strength belonging to the target statistical elements. And the preparing the reference information further incorporates identification information of the additional access point and the reference value obtained for the additional access point into the reference information.

Another method for providing reference information for connecting to a wireless data network according to still another aspect of the present invention, comprises: causing a property statistical table to reflect received mutual communication property information, the mutual communication property information including, for at least one access point, a signal strength value calculated from two signal strength values determined based on communication property of each of the at least one access point, identification information of each of the at least one access point, and type information of a wireless communication terminal; obtaining a reference value from a representative value determined from target statistical elements registered in the property statistical table, for each of one or more access points, if receiving from a particular wireless communication terminal a request of access point reference information in which access point identification information is specified for said one or more access points and type information of the particular wireless communication terminal is included, the target statistical elements being related to the each access point and the type information of the particular wireless communication terminal; and preparing reference information by incorporating therein the reference value obtained for each of said one or more access points and transmitting the prepared reference information to the particular wireless communication.

In an embodiment of the present invention, the two signal strength values are a first signal strength value, determined based on data receiving speeds provided in using data service by each of the at least one access point, and a second signal strength value, smaller than the first signal strength value, determined based on receiving speeds equal to or below a predetermined speed among data receiving speeds provided in using data service by the each access point. In this case, the signal strength value is a value, calculated from the two signal strength values, between the first and second signal strength values.

In another embodiment of the present invention, the second signal strength value, smaller than the first signal strength value, detected in a successful connection process to the each access point.

In an embodiment of the present invention, the causing the property statistical table to reflect the mutual communication property information, if another received mutual communication property information contains an arbitrary signal strength value which is different in property from the signal strength value, further comprises: determining a single value between the arbitrary signal strength value and a third value based on the arbitrary signal strength value and the third value; and causing the property statistical table to reflect the another mutual communication property information in after replacing the arbitrary signal strength value contained in the another mutual communication property information with the determined single value. In this embodiment, the arbitrary signal strength value of different property is a signal strength value determined based on a data receiving speed provided in using data service by an access point, and the third value is a value pre-assigned for type information of a wireless communication terminal and a corresponding access point that are contained in the another received mutual communication property information.

In an embodiment of the present invention, the causing the property statistical table to reflect the mutual communication property information comprises: determining one classifying item among predetermined classifying items based on date and time at which the signal strength value is obtained or at which the mutual communication property information is received; and causing the property statistical table to reflect the mutual communication property information in such a way that the mutual communication property information is classified into the property statistical table by the determined classifying item. And, the obtaining the reference value comprises: determining one classifying item among predetermined classifying items based on date and time at which the request of access point reference information is received; and obtaining the reference value from statistical elements belonging to the determined classifying item among the target statistical elements.

In an embodiment of the present invention, the obtaining the reference value further obtains, for at least one additional access point besides said one or more access points specified in the request, a reference value from a representative value determined from target statistical elements for the at least one additional access point and type information of the particular wireless communication terminal, and the preparing the reference information further incorporates identification information of the additional access point and the reference value obtained for the additional access point into the reference information.

In the aforementioned methods for providing reference information for connecting a wireless data network, the obtaining the reference value comprises applying a specific rule in obtaining the reference value in accordance to an embodiment of the present invention, the specific rule being that more recent element among the target statistical elements functions in higher proportion. In addition, in case any one of said one or more access points is an unregistered access point, the obtaining the reference value further comprises obtaining a reference value to be applied for the unregistered access point from a reference value obtained for at least one different access point for which target statistical elements are registered in the property statistical table.

An apparatus for providing information for connecting to a wireless data network to a wireless communication terminal according to still another aspect of the present invention, comprises: a first processor configured to cause a property statistical table to reflect mutual communication property information if receiving the mutual communication property information that includes identification information of an access point, a value of a first property signal strength determined based on a data receiving speed provided for a wireless communication terminal in using data service by the access point, and type information of the wireless communication terminal; and a second processor configured to conduct operations, if a request of access point reference information including identification information of one or more access points and type information of a wireless communication terminal is received, that comprise obtaining a reference value, for each of said one or more access points, from target statistical elements registered in the property statistical table, the obtained reference value being smaller than an average of values of the first property signal strength belonging to the target statistical elements that relate to the each access point and the type information of the wireless communication terminal, and preparing reference information by incorporating therein the reference value obtained for each of said one or more access points and transmitting the prepared reference information to a wireless communication terminal that transmitted the request.

Another apparatus for providing information for connecting to a wireless data network to a wireless communication terminal according to still another aspect of the present invention, comprises: a first processor configured to cause a property statistical table to reflect mutual communication property information if receiving the mutual communication property information that includes identification information of an access point, a signal strength value calculated from two signal strength values determined based on communication property of the access point, and type information of the wireless communication terminal; and a second processor configured to conduct operations, if a request of access point reference information including identification information of one or more access points and type information of a wireless communication terminal is received, that comprise obtaining a reference value, for each of said one or more access points, from target statistical elements registered in the property statistical table, from a representative value determined from the target statistical elements that relate to the each access point and the type information of the wireless communication terminal, and preparing reference information by incorporating therein the reference value obtained for each of said one or more access points and transmitting the prepared reference information to a wireless communication terminal that transmitted the request.

### Advantageous Effects

The present invention described above or at least one embodiment of the present invention described in detail with reference to appended drawings allows selecting an access point exhibiting signal strength high enough for an enhanced data service considering mutual communication property between a wireless communication terminal and a wireless communication network in addition to signal strength due to an access point of the wireless communication network, thereby enabling the user to use a high speed wireless data network through an access point that can provide a statistically superior data speed for the corresponding terminal type even if signal strength of each access point is the same to each other. This leads to increase of satisfaction of the whole communication service users.

### DESCRIPTION OF DRAWINGS

FIG. 1 illustrates one example of a network where a method for constructing, providing, and using information about mutual communication property between an access point of a wireless network and terminal type according to one embodiment of the present invention is carried out;

FIG. 2 illustrates one example of a mobile communication terminal according to one embodiment of the present invention, capable of reporting mutual communication property between the terminal and a wireless network access point and using reference information about provided access points;

FIG. 3 illustrates a logical structure of an intelligent access point selecting agent according to one embodiment of the present invention, which reports mutual communication property related to a wireless network access point and utilizing reference information about provided access points and its relationship to neighboring constituting elements;

FIG. 4 illustrates a process of checking the communication history and signal strength of a wireless communication terminal in a repeated manner to figure out the change of communication property when the terminal uses a data service according to one embodiment of the present invention;

FIG. 5 illustrates an example of sample information constructed by taking samples representing communication property from the information checked repeatedly according to the embodiment of FIG. 4;

FIG. 6 illustrates one example of determining from samples representing communication property a proper lower limit value contained in mutual communication property information between an access point of a wireless communication network and a terminal type according to one embodiment of the present invention;

FIG. 7 illustrates another example of determining from samples representing communication property a proper lower limit value contained in mutual communication property information between an access point of a wireless communication network and a terminal type according to another embodiment of the present invention;

FIG. 8 illustrates one example of determining from samples representing communication property an improper upper limit value contained in mutual communication property information between an access point of a wireless communication network and a terminal type according to one embodiment of the present invention;

FIG. 9 is a flow diagram for exchanging signals of a method for configuring, providing, and using mutual communication property information according to one embodiment of the present invention;

FIGS. 10 and 11 illustrate examples of mutual communication information for reporting to an external server according to an embodiment of the present invention;

FIGS. 12 to 14 illustrate property statistical tables constructed in different forms from each other for registering received mutual communication property information according to embodiments of the present invention;

FIG. 15 illustrates an example of a request document containing identification information of neighboring access points found and being transmitted to an external server to obtain reference information about an access point according to one embodiment of the present invention;

FIG. 16 illustrates distribution of proper lower limit values and improper upper limit values (or connection threshold values) registered in a statistical table from reported mutual communication property information, used for calculating a connection recommended value which is reference information for determining an access point according to one embodiment of the present invention;

FIG. 17 is an example of AP reference information constructed to be provided for a wireless communication terminal according to one embodiment of the present invention;

FIG. 18 illustrates an example where relative strength is determined based on a connection recommended value contained in the received AP reference information with respect to each signal strength of neighboring APs according to one embodiment of the present invention;

FIG. 19 illustrates one example of a process for obtaining an connection threshold value belonging to mutual communication property information according to another one embodiment of the present invention;

FIG. 20 illustrates a logical structure of an intelligent access point selecting agent according to another one embodiment of the present invention, collecting mutual communication property related to an access point of a wireless communication network and using the mutual communication property for selecting an access point of the wireless communication network;

FIG. 21 illustrates one example of a property statistical table constructed for registering mutual communication property information collected, according to the embodiment of FIG. 20;

FIG. 22 illustrates a case where a connection recommended value determined for a different access point is applied for an access point unregistered in a property statistical table according to one embodiment of the present invention;

FIG. 23 illustrates a process of learning a connection recommended value to be used for an access point unregistered in a property statistical table according to another one embodiment of the present invention;

FIG. 24 illustrates a process of compensating relative strength of current signal strength of an AP obtained based on a connection recommended value contained in received AP reference information by reflecting channel overlapping factors according to one embodiment of the present invention; and

FIG. 25 illustrates one example of an access control server according to one embodiment of the present invention, constructing statistical information about mutual communication property information and based on the information, constructing and providing AP reference information.

### MODE FOR INVENTION

In what follows, embodiments according to the present invention will be described in detail with reference to appended drawings.

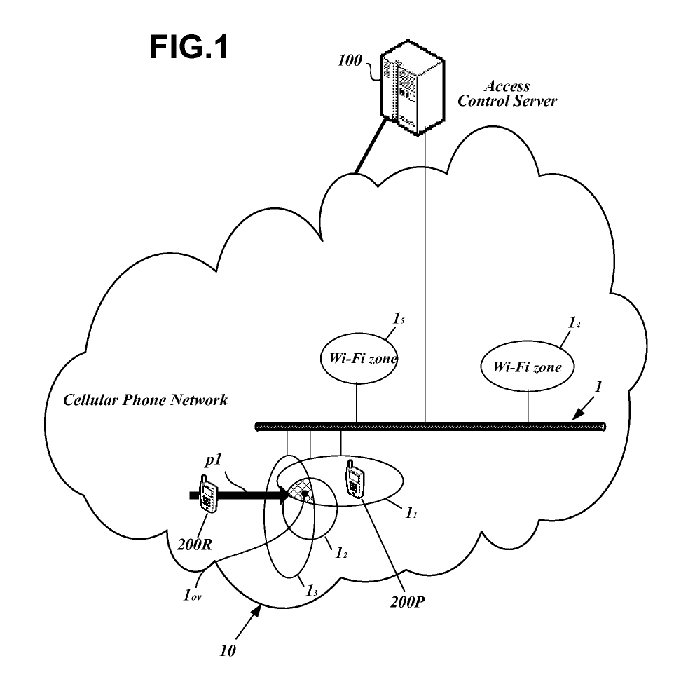

FIG. 1 illustrates one example of a network where a method for constructing, providing, and using information about mutual communication property between an access point of a wireless network and terminal type according to one embodiment of the present invention is carried out, which comprises two heterogeneous networks constructed as communication infrastructures different from each other such as a mobile phone communication network 10 and a wireless LAN network for high-speed data service 1, 1_{I}; and an access control server 100 connected to the mobile phone communication network 10 and a wireless LAN network 1, receiving mutual communication property information about an access point (hereinafter, it is called “AP”) of the wireless LAN network (in fact, the corresponding service zone 1_{I}) from a wireless communication terminal within the corresponding communication network and based on the received mutual communication property information, configuring reference information about an AP, and providing the reference information to a wireless communication terminal. In what follows, for the convenience of description, a cellular network based on the 3 G communication is assumed as an example of the mobile phone communication network 10 (in what follows, a “cellular network”) and a wireless LAN network based on the Wi-Fi communication is assumed as an example of the high-speed wireless LAN network 1,1_{I} (in what follows, it is called a “Wi-Fi” network). In what follows, technical principles and concept are described in detail with reference to the cellular network 10 mainly intended for voice communication and the Wi-Fi network 1 used together as a data communication network for data services; however, since technical principles and concept of the present invention can be directly applied to another data communication network other than the Wi-Fi network, for example, Wibro network, technical scope of the present invention defined by appended claims is not limited simply by the fact that a data communication network for application is different from what is described in this document.

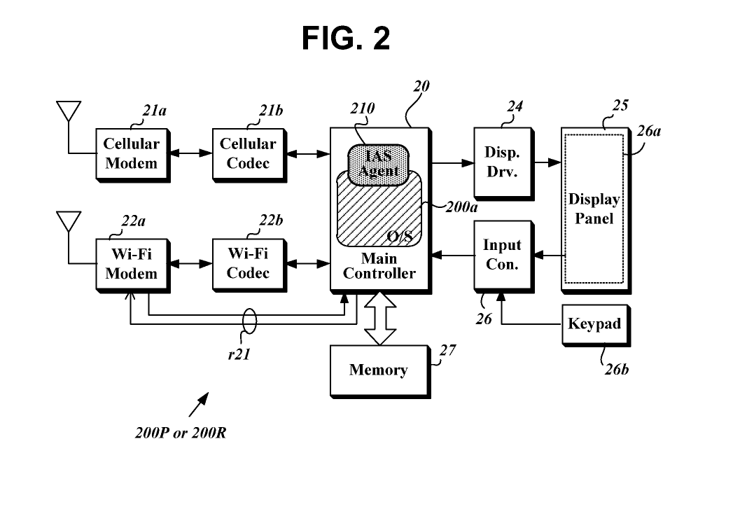

A mobile communication terminal provides the access control server 100 with property information of a data service at the time of using the APs of the Wi-Fi network 1 and in case of needs, requests and receives reference information of an AP containing mutual communication property information; the mobile communication terminal has a structure as shown in FIG. 2. The mutual communication property information refers to the information specifying communication property that a wireless communication terminal undergoes at the time of using a data service through the corresponding AP.

The wireless communication terminal 200P or 200R whose structure is shown in FIG. 2 comprises a cellular modem 21a (which is an element including a module processing RF signals) communicating with the corresponding communication network by modulating or demodulating a signal in compliance with the signaling system specified by the cellular network 10; a cellular codec 21b encoding data or decoding encoded data in compliance with communication protocols adopted in the cellular network 10; a Wi-Fi modem 22a (which is an element including a module processing RF signals) communication with the corresponding communication network by modulating and demodulating a signal in compliance with the signaling system specified by the Wi-Fi network 1; a Wi-Fi codec 22b encoding data or decoding encoded data in compliance with communication protocols adopted in the Wi-Fi network 1; a display panel 25 for displaying an image, character, and the like; a display driving unit 24 driving the display panel 25 for arbitrary data to be displayed on the display panel 25; a touch sensor 26a attached on the front surface of the display panel 25; a keypad 26b equipped with keys and/or buttons; an input controller 26 sensing a user input and/or selection on the touch sensor 26a and keypad 26b and outputting input information corresponding thereto; a main controller 20 transmitting data to, receiving data from, or controlling the above-mentioned elements in accordance to input information to make the operation carried out according to the input information outputted from the input controller 26, and controlling the display driving unit 24 to control a UI screen for displaying the result of transmitting, receiving, or controlling data or for selecting operation wanted by the user; and a memory unit 27 providing data storage space required for operating the main controller 20 or a process executed by the operation.

The main controller 20 includes an operating system 200a, which carries out command codes such as firmware installed inside thereof and thus carries out driving hardware resources of the wireless communication terminal 200P, 200R and exchange of relevant signal and/or information with the corresponding resources; and an intelligent AP selecting agent (IAS) 210 (hereinafter, it is called an “AP selecting agent” for short) which, if the terminal uses a data service by using an arbitrary AP of the Wi-Fi network 1, recognizes properties of the service and provides the recognized information to an external server and if needed, requests and receives reference information of an AP containing mutual communication property information as described above.

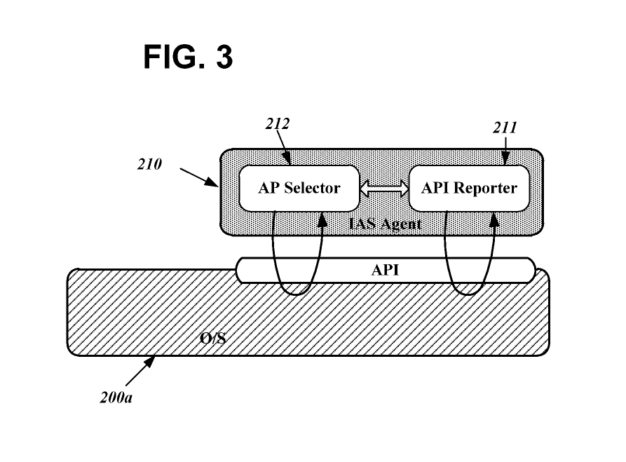

The AP selecting agent 210 is a process or an application implemented in the wireless communication terminal 200P, 200R; as shown in FIG. 3, the AP selecting agent 210 can be provided in the form of software having the structure of program codes executed based on the operating system 200a. In case where the AP selecting agent 210 is provided in the form of software, the AP selecting agent stored in a large capacity storage means equipped in a particular server is downloaded to the wireless communication terminal 200P, 200R through a conventional on-line purchasing process from the particular server connected to a communication network through its own communication means and the AP selecting agent is executed after it is installed. Depending on a situation, at least part of the functions of the AP selecting agent 210 described in detail below can be provided to the wireless communication terminal 200P, 200R in the form of middleware, platform based on which applications are carried out, or part of the operating system 200a. In other ways, as the AP selecting agent 210 includes a hardware structure, part of the functions described in detail below can be carried out by the hardware. Therefore, implementation form or type of resources used of the AP selecting agent 210 whose structure and operating method are described in various embodiments according to the present invention does not limit the technical scope of the present invention.

The AP selecting agent 210, as shown in FIG. 3, comprises an AP information reporting unit 211 using a data service through an arbitrary AP and obtaining and providing property information at the time of using the service; and an AP selecting unit 212 selecting an AP based on reference information of an AP according to the terminal type provided from a remote server and connecting the AP to the Wi-Fi network 1. The AP selecting agent 210, the AP information reporting unit 211, and the AP selecting unit 212, for the case of part of functions described in detail below, carry out their operation by requesting particular functions (for example, input and output through a display screen, communication to and from the outside based on a protocol, checking a communication state, checking hardware state, timer, and so on) provided individually by hardware components illustrated in FIG. 2 and the operating system 200a through application program interfaces (APIs) provided by the operating system 200a

The structure of the mobile communication terminal 200P, 200R illustrated in FIG. 2 is only an example intended to describe embodiments of the present invention in a specific and illustrative manner to help understand the technical principles and scope of the present invention. Wireless communication terminals implementing the technical principles of the present invention can further include constituting elements providing various functions not shown in FIG. 2 or exclude part of constituting elements illustrated.

While the wireless communication terminal 200P including constituting elements illustrated in FIGS. 2 and 3 is located in one 1₁ of Wi-Fi zones as shown in FIG. 1, if a current Wi-Fi network is activated for use, the Wi-Fi modem 22a transmitting a probing packet periodically to the channels allocated in a Wi-Fi signal band, for example, each of thirteen channels, receives a response packet in response to the probing packet from neighboring APs; at this time, the Wi-Fi modem 22a obtains RSSI (Received Signal Strength Indicator) from the response packet signal and extracts channel information, service set identifier (SSID), and MAC (Media Access Control) address of the AP. If the Wi-Fi modem 22a stays in such a state, the operating system 200a usually selects one AP and requests for connection thereto, by which an IP address is allocated to the operating system 200a and is set up as a local IP address. In the embodiments according to the present invention, an AP is selected by an AP selecting unit 212 of the AP selecting agent 210 and the selected AP is notified to the operating system 200a. In order for the AP selecting unit 212 to select one AP, AP reference information received by requesting it from an external server is used, which will be described in detail below. While a local IP address is set up for the wireless communication terminal 200P, an arbitrary application executed within the wireless communication terminal 200P can use a data service through the Wi-Fi network 1.

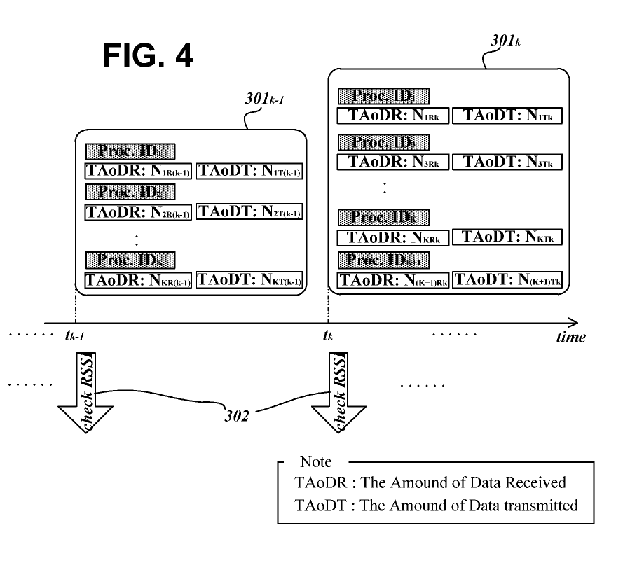

Meanwhile, the AP information reporting unit 211 of the AP selecting agent 210 recognizes the activation of the wireless communication terminal 200P for using a Wi-Fi network. The activation can be checked by the AP information reporting unit's 211 periodically inquiring the operating system 200a about the activation or by registering the AP information reporting unit 211 for the operating system 200a as a recipient of an event generated when the terminal 200P is activated and detecting the corresponding event. If a Wi-Fi network use is activated, the AP information reporting unit 211 requests and obtains a data communication history 301, (i= . . . , k−1, k, . . . ) from the operating system 200a as shown in FIG. 4 to check repeatedly how an application or applications executed in the wireless communication terminal 200P use the currently connected Wi-Fi network 1. In case a data communication history about all the available communication networks rather than the communication network currently connected by the wireless communication terminal 200P is provided from the operating system 200a in response to the request, only the information related to the Wi-Fi network 1 is extracted and only the information of the corresponding communication network is utilized as shown in FIG. 4.

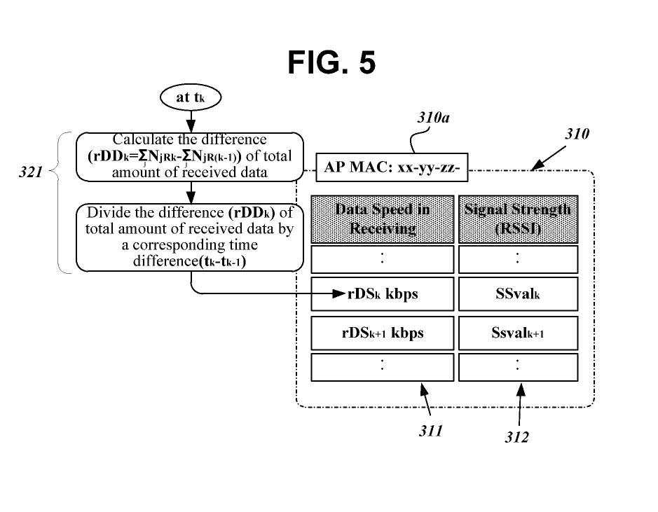

The AP information reporting unit 211 reads 302, at each interval (tᵢ, i= . . . , k−1, k, . . . ) of obtaining the data communication history 301ᵢ, signal strength value of a current AP detected r21 by the Wi-Fi modem 22a, namely, RSSI value, SSID, and MAC address through an API provided by the operating system 200a and checks signal strength at the corresponding time point. In another one embodiment according to the present invention, the AP information reporting unit 211 checks signal strength once out of many times the data communication history is obtained. In this way, once signal strength is checked, the AP information reporting unit 211 constructs communication property sample information at the time of using a data service as shown in FIG. 5. Identification information of a currently connected AP, for example, MAC address is checked through the operating system 200a and records the checked identification information in the communication property sample information as a target object 310a. The communication property sample information 310 illustrated in FIG. 5 is a set of entries comprising the entire reception speed 311 (at this point, the term of “entire” is used to make clear that the reception speed relies on the whole executable entities (processes or applications) carrying out data communication within the corresponding terminal and in what follow, if the term only of “reception speed” is used, it should be understood that the term stands for “entire reception speed”) and signal strength value 312 at each time point (tᵢ, i= . . . , k−1, k, . . . ); the value rDSᵢ of the entire reception speed within an arbitrary entry is obtained by dividing the amount of data rDDᵢ by the corresponding time interval (Δt=tᵢ₋₁−tᵢ) 321, where the amount of data rDDᵢ is obtained by subtracting the total amount of received data (ΣN_{jR(i-1)}, j=1, 2. 3, . . . ) in the data communication history 301ᵢ₋₁ obtained at the previous time point from the total amount of received data (ΣN_{jRi}, j=1, 2. 3, . . . ) in the data communication history 301ᵢ of FIG. 4 obtained at the corresponding time point tᵢ.

In this way, the operation of obtaining a reception speed value rDSᵢ and signal strength value SSvalᵢ at each time point tᵢ and adding the values to the communication property sample information 310 as an entry is continued until the network used for the wireless communication terminal 200P is switched to the cellular network 10 or an AP used for accessing the Wi-Fi network 1 is changed to another AP. Switching a network in use or change of an AP can be known through an event generated by the operating system 200a. Of course, it can also be known by a periodic check. In case a network in use is switched to the cellular network 10 or an AP is changed to another, the AP information reporting unit 211 estimates a “proper lower limit value” (means a minimum signal strength for good bandwidth) which is one of mutual communication property between the wireless communication terminal 200P and the corresponding AP from the communication property sample information 310 constructed at the time of using a service. The proper lower limit value refers to an approximate minimum value of signal strength regarded to have a property ensuring high quality communication speed while the wireless communication terminal 200P performs communication with the corresponding AP; as described below, the AP information reporting unit 211 estimates a proper lower limit value from the communication property sample information 310 obtained through the method described above at the time of using a service obtained.

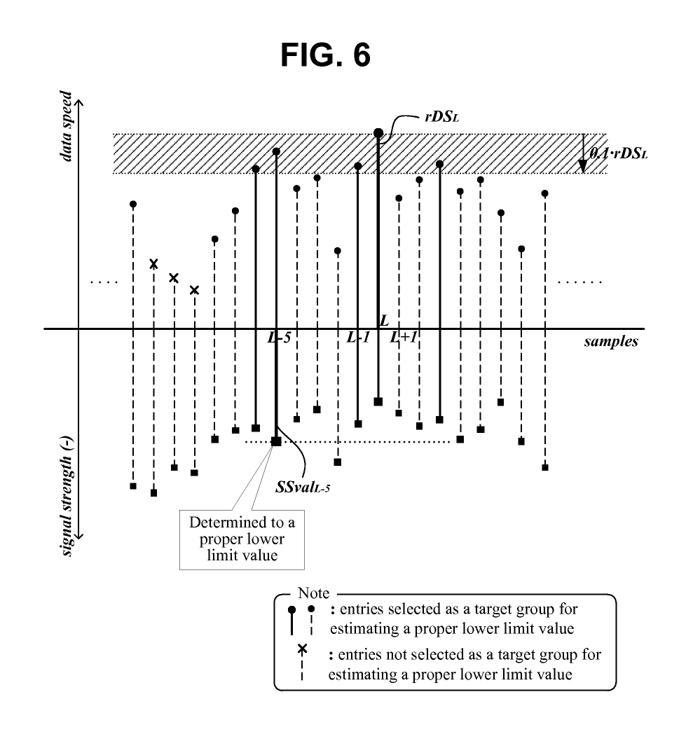

The AP information reporting unit 211 searches the communication property sample information 310 constructed by itself for those entries showing a reception speed higher than a predetermined, particular lower limit value, for example 1 Mbps (this particular lower limit value can be applied adaptively according to an average speed in the corresponding area of the cellular network 10, which is one of wireless communication networks used) and collects them into a target group. The AP information reporting unit 211 then selects those entries within the target group showing a reception speed corresponding to a predetermined ratio, for example, 10%, 15%, or 20% or below of the reception speed of an entry showing the maximum reception speed among the target group. Lastly, the AP information reporting unit 211 determines the minimum value among signal strength values of the selected entries as a proper lower limit value. FIG. 6 is a graphical illustration of the description above to help understand how the proper lower limit value is determined. In the example of FIG. 6, the data reception speed rDS_{L} of an entry obtained at the time t_{L} among the entries selected as a target group reveals the maximum value and the smallest signal strength value SSval_{L-5} among the samples (the corresponding entries of the communication property sample information 310 and those indicated by solid line) within the target group showing a reception speed within 90% of the maximum value (a difference of 10% or below) is determined as the proper lower limit value. In another one embodiment according to the present invention, all of the entries showing a reception speed equal to or above the determined, particular lower threshold speed can be assigned to the target group. In other words, among entries having a reception speed equal to or above the determined, particular lower threshold speed, the lowest signal strength value can be determined as a proper lower limit value.

Meanwhile, for the case of an embodiment where signal strength is not checked at each time of calculating the entire reception speed, there can be an entry that does not hold a signal strength value at the time of calculating the entire reception speed. For this case, a signal strength value checked at a previous time point closest to the corresponding time point is employed. This scheme is applied for embodiments below.

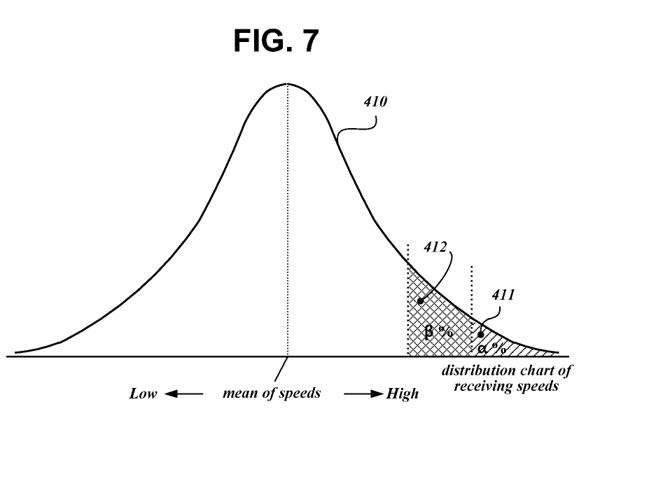

In another embodiment according to the present invention, a maximum reception speed within the communication property sample information 310 may not be used as a reference for estimating a proper lower limit value. Since wireless communication inherently shows significant variation, if a significantly superior property is observed at some instant, the number of samples that can be chosen from the instantaneous change can be made too small. In that case, since a value estimated as a proper lower limit value can be taken as the signal strength value for the case where a significantly superior communication property is observed, a large difference can be developed from the value intended for the term of an actual, proper lower limit value. Therefore, in the present embodiment, as shown in FIG. 7, reception speeds 411 belonging to the region of a particular ratio (α%, for example, 3% or 5%) of the maximum speed in the distribution 410 of reception speeds of target entries showing a reception speed equal to or above the predetermined, particular lower threshold speed in the communication property sample information 310 are excluded and those reception speeds 412 of a particular ratio (β%, for example, 5% or 10%) in the next order are chosen and the value showing the smallest signal strength among the samples (the corresponding entries of the communication property sample information 310) having the chosen reception speeds is estimated as the proper lower limit value.

Besides the method for estimating a proper lower limit value described with reference to FIGS. 6 and 7, whatever method can be used once the method in question operates in such a way to select reception speed samples that enables estimation of a data reception speed obtained as a result not from the request of a process or an application run in the wireless communication terminal 200P for receiving an intermittent, small amount of data but from the request for a large amount of high speed data. It can be considered as another method for obtaining a proper lower limit value described with reference to FIGS. 6 and 7 if the method in question estimates the smallest signal strength value corresponding to the selected reception speed samples as a proper lower limit value.

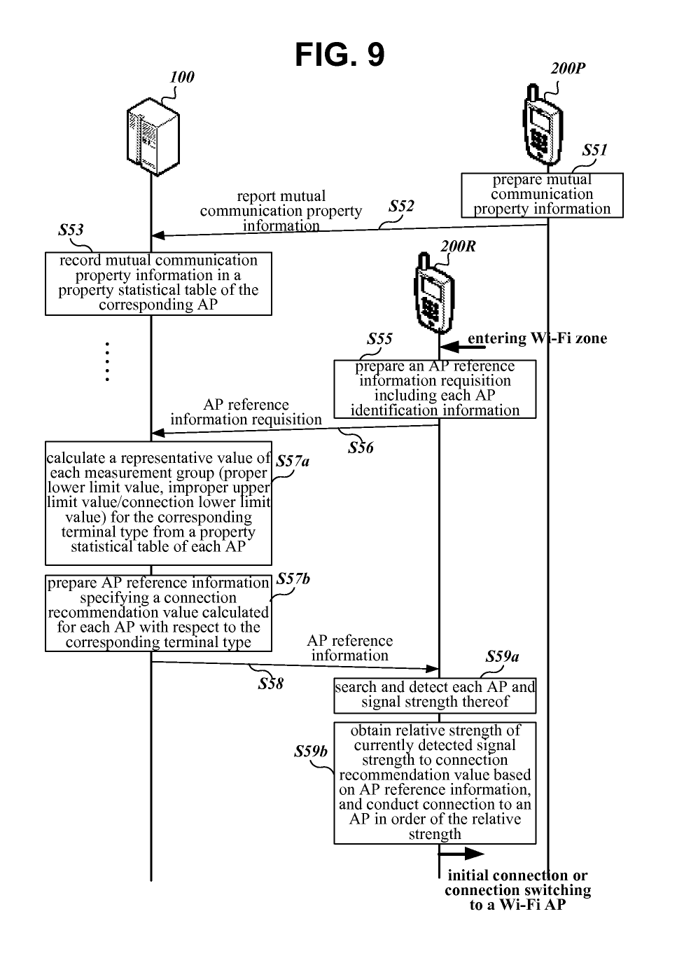

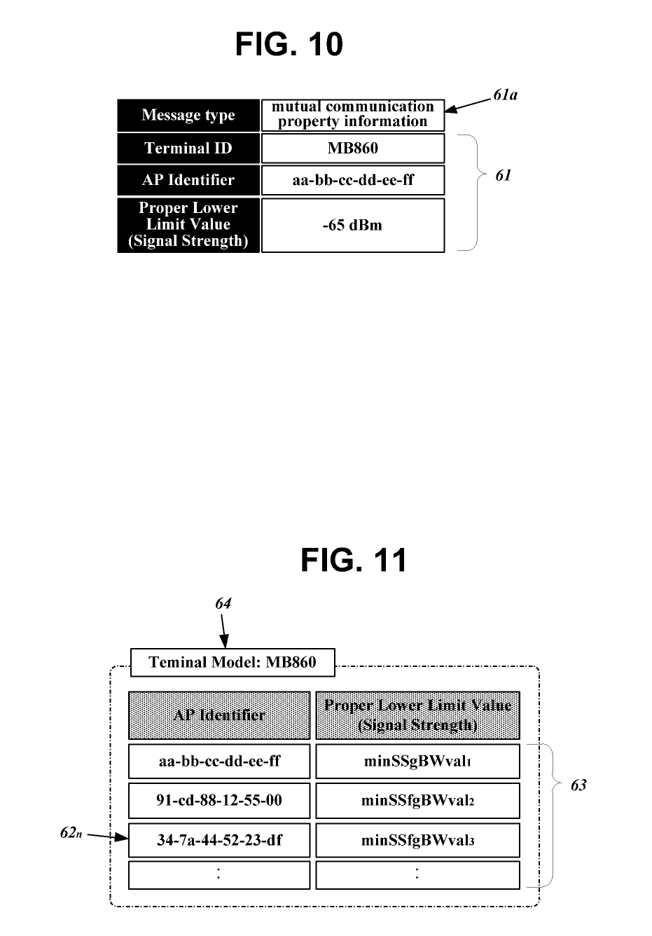

Once a proper lower limit value is estimated from any one of methods described in the aforementioned embodiments, the AP information reporting unit 211 constructs mutual communication property information as illustrated in FIG. 9 and report the mutual communication property information to the access control server 100. To this purpose, first of all, the AP information reporting unit 211, as shown in FIG. 10, constructs mutual communication property information 61 by incorporating the estimated proper lower limit value, AP identification information 310a recorded in the communication property sample information 310, and type information (for example, model name) of the wireless communication terminal 200P thereto S51; and provides the constructed mutual communication property information 61 to the access control server 100, S52. At this time, information (such as code, text, and so on) 61a indicating that the provided information corresponds to mutual communication property information is recorded in the header of the provided information. The type information of a wireless communication terminal can be known from terminal information obtained by requesting the type information from the operating system 200a. The terminal information returned from the operating system 200a includes model information, version information of the operating system 200a, and so on.

In order for the AP information reporting unit 211 to provide the mutual communication property information to the access control server 100, an address of the access control server 100 (for example, URL) is previously assigned to the AP selecting agent 210 or the AP selecting agent 210 allows the user to set up the address through an environment setting window provided in the form of an appropriate UI; the address information assigned or set up as described above is shared between the AP information reporting unit 211 and the AP selecting unit 212. The AP information reporting unit 211 requests generation of communication sockets for mutual data exchange while providing the address of the access control server 100 to the operating system 200a; according to the request, the operating system 200a establishes TCP connection to the access control server 100 and generates a communication socket associated with the connection and returns identification information of the communication socket to the AP information reporting unit 211. Then the AP information reporting unit 211 delivers the mutual communication property information to the operating system 200a by using the returned identification information through the generated communication socket, thereby reporting the mutual communication property information to the access control server 100.

In one embodiment according to the present invention, the AP information reporting unit 211 can include information about “improper upper limit value” of the corresponding AP in addition to the mutual communication property information reported to the access control server 100. The improper upper limit value refers to an approximate upper limit value of signal strength estimated to provide low service quality which does not satisfy the speed required by a terminal for communication with the corresponding AP.

In another one embodiment according to the present invention, information about “connection threshold value” can be added to the mutual communication property information instead of the improper upper limit value. The connection threshold value refers to an approximate minimum signal strength estimated when an attempt for connecting to the corresponding AP succeeds with a high probability.

The improper upper limit value is obtained from estimation through a method similar to the method for obtaining a proper lower limit value described in detail above. To describe more specifically, first of all, the AP information reporting unit 211 checks data request information delivered from a different application (for example, a media player) run in the wireless communication terminal 200P to obtain an improper upper limit value, The data request information includes information about transfer type along (or play type) which the different application request a data object (for example, a contents file) from an external server or information about bandwidth (transfer speed) required for playing the contents file; the data request information is delivered to the AP selecting agent 210 through an intent object, which is an information structure constructed in compliance with an information format defined by the operating system 200a for the purpose of exchanging information or commands among processes, and shared by the AP information reporting unit 211. The intent object contains data request information to be delivered and target information of the delivery, namely, identifier of the AP selecting agent 210 (for example, a package name). If the different application generates an intent object as described above and request delivery thereof from the operating system 200a through an API, the intent object is relayed to the AP selecting agent 210 by the operating system 200a and shared by the AP information reporting unit 211.

The data request information delivered by the different application includes transfer type of the data object, for example, information indicating downloading or streaming; in the case of streaming, information about speed required for playing the data object is further included. In another one embodiment according to the present invention, the different application does not deliver data request information about a data object requested for transfer from the outside but delivers URL for accessing the data object to the AP selecting agent 210 instead. In the present embodiment, the AP information reporting unit 211 recognizes the URL delivered to the AP selecting agent 210, generates a request compliant with the communication protocol of the URL (for example, HTTP request), transmits the request to the corresponding server, analyzes mime-type or meta data from part of the data related to the corresponding data object received according to the transmission and figures out the transfer type or required streaming speed of the data object.

As described above, if data request information or URL about a data object is delivered from a different executable entity, the AP information reporting unit 211 obtains an improper upper limit value according to a method described below. If such information is not delivered, the improper upper limit value may not be obtained.

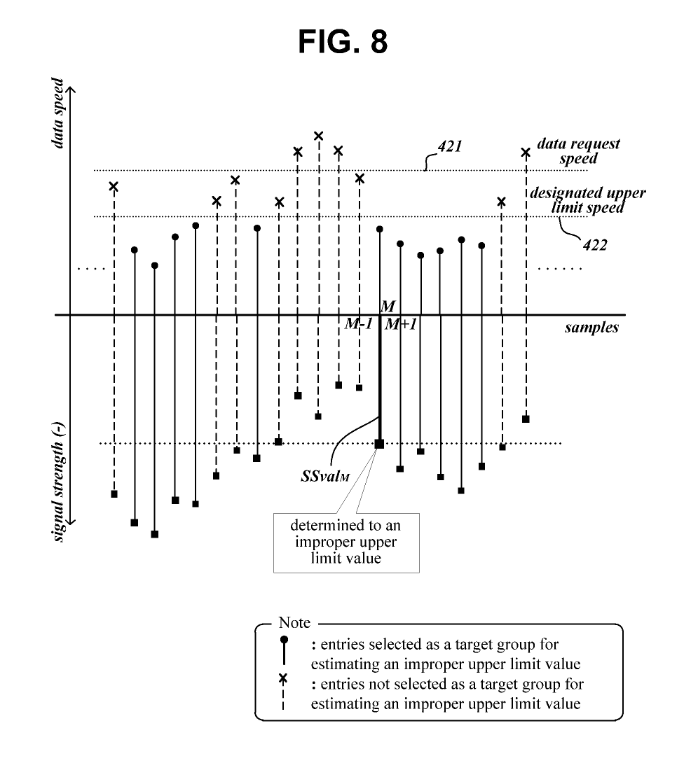

If it is determined to obtain an improper upper limit value, the AP information reporting unit 211 searches the communication property sample information 310 constructed at the time of using a data service as described above for entries from the moment the determination is made; that is, the AP information reporting unit 211 searches for those entries whose speed is slower than a reference speed specified by the delivered or recognized data request information and at the same time, equal to or slower than a predetermined particular upper threshold speed, for example, 0.2 Mbps (this particular upper threshold speed can be applied after being adaptively changed according to an average speed in the corresponding area of the cellular network 10, which is one of wireless communication networks in use) and assigns the entries found into a target group. If the data request information specifies “download transmission” for a data object, it indicates requesting a maximum capacity for a transmission speed supported by communication resources; therefore, the reference speed is regarded as ∞ (infinity) but the reference speed is otherwise determined by a requested speed for streaming. If a target group is determined, the AP information reporting unit 211 determines the highest signal strength value within the target group as an improper upper limit value. FIG. 8 is a graphical illustration of the description above to help understand the entries assigned to the target group and how an improper upper limit value is determined from the entries. The example of FIG. 8 corresponds to a case where a reference speed 421 determined by data request information is higher than a predetermined particular upper threshold speed 422; therefore, the example illustrates that the highest signal strength value SSval_{M} among samples (the samples indicated by solid lines in the example of FIG. 8) of the target group exhibiting a speed equal to or below the predetermined particular upper threshold speed 422 is determined as an improper upper limit value.

In one embodiment according to the present invention, only part of entries belonging to the target group is taken and the highest one of signal strength values of the part of entries is determined as an improper upper limit value. For example, an improper upper limit value can be determined from the entries occupying a fixed ratio in the central area of a distribution of entries belonging to the target group, for example, from those entries corresponding to 30% or 50% of the central area.

While a process for obtaining an improper upper limit value is carried out, if communication property in relation to the corresponding AP is considerably good and all the entries are equal to or below the reference speed or a predetermined particular upper threshold speed or the number of entries satisfying the above conditions is too small (that is, the number is equal to or below a predetermined limiting number or the ratio of the number to the total number of entries measured is equal to or below a predetermined limiting ratio), the AP information reporting unit 211 does not determine an improper upper limit value. Therefore, in this case, only the proper lower limit value obtained previously is included in the mutual communication property information or reported to the access control server 100. Also, the improper upper limit value can also be stored in association with the information about the date at which the value is obtained or included in the mutual communication property information.

Meanwhile, the information about connection threshold value described above can be obtained by requesting it from the AP selecting unit 212 while providing identification information of an AP related to the mutual communication property information. Differently, the information about connection threshold value can be requested without providing identification information of the AP. In the latter case, since a list of connection threshold values obtained for a plurality of APs is received along with identification information of each AP according to the request, based on the identification information, only a connection threshold value (or along with the time point at which the connection threshold value is checked) for an AP that attempts to report current mutual communication property information is taken. If a connection threshold value received from the AP selecting unit 212 is equal to or above a proper lower limit value included in the mutual communication property to be reported, the AP information reporting unit 211 discards the received connection threshold value and does not include it in the mutual communication property information. A method for the AP selecting unit 212 obtaining the connection threshold value from estimation will be described below.

It should be understood that construction of communication property sample information, estimation of a proper lower limit value or improper upper limit value based on the sample information, and reporting of mutual communication property information as described above are carried out in the same manner for a different AP if the mobile communication terminal 200P is connected to the different AP.

In one embodiment according to the present invention, instead of reporting switching to a communication network or change of an AP each time, until particular conditions are met, AP identification information and a proper lower limit value for the respective APs employed for using a data service are obtained and stored as shown in FIG. 11 (at this time, information about the date at which each proper lower limit value is obtained can be stored together); if the particular conditions are met, a set 63 of pairs (62ₙ, n=1, 2, 3, . . . ) (according to an embodiment of the present invention, each pair can include either of an improper upper limit value and connection threshold value) collected up to that time, each of which consisting of AP identification information and a proper lower limit value and type information 64 of the wireless communication terminal 200P can be provided after being incorporated together into mutual communication property information. In case the mutual communication property information includes a connection threshold value, to construct the mutual communication property information, information related to the connection threshold value is requested from the AP selecting unit 212; if there exists a connection threshold value obtained with respect to an AP belonging to the set 63, the connection threshold value constitutes information in the form of a pair together with a recommended lower limit value for the corresponding AP (if information about the date at which the connection threshold value is checked is available, the information about the date is also included), after which the information can be provided. The particular conditions can correspond to the case where the screen of the wireless communication terminal 200P is switched to a lock state, the case where a request for suspending execution of the AP selecting agent 210 is released, or a particular time of a day (which can also be designated through environment setting of the AP selecting agent 210).

Meanwhile, if wireless communication terminals equipped with the AP selecting agent 210 constructs and reports mutual communication property information according to the method described above S52, the access control server 100, as shown in FIG. 9, records each mutual communication property information being received in a statistical table (hereinafter, it is called a “property statistical table” for short) of each terminal already classified for the respective APs as a statistical element S53. The term of “statistical table” used in this document for a set of statistical elements classified for each AP is not only meant for referring to data objects classified individually, for example, a set of statistical elements implemented individually in the form of files but also for indicating individual groups of statistical elements that can be identified based on AP identification information, where, even if statistical elements related to two or more APs belong to the same object as the whole statistical elements are distributed into one or several objects, the statistical elements can be identified from each other since the AP identification information is recorded in the corresponding object.

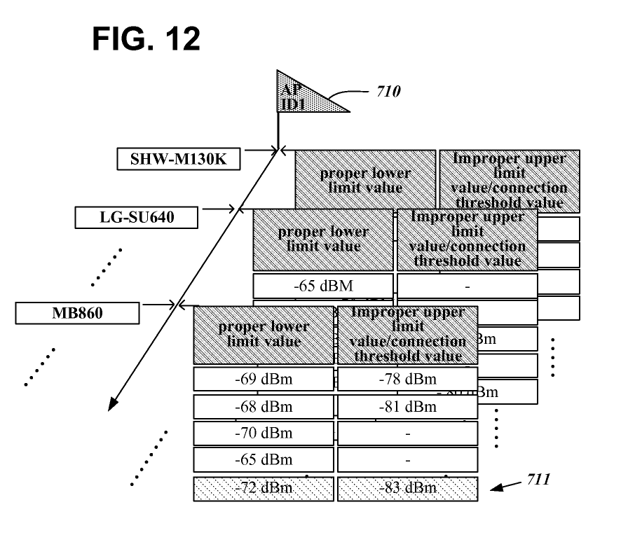

FIG. 12 is a graphical illustration to help understand one example of a statistical table according to one embodiment of the present invention, where mutual communication property information received from the AP selecting agent 210 is registered as a statistical element. In the example of FIG. 12, it is assumed that mutual communication property information (including an improper upper limit value or connection threshold value) received by an AP identified as “ID1” from an artificial wireless communication terminal marked as “MB860” is additionally registered for a property statistical table of the corresponding AP 710 as a single statistical element 711, namely, a measurement value (in fact, the measurement value is a value “estimating” signal strength intended by the term (proper lower limit value, improper upper limit value/connection threshold value) but since the estimated value itself is measured by the terminal, the term of “measurement value” is used in the present document). It is still possible to register information about a date and time in the corresponding statistical table if mutual communication property information includes information about a date and time (the date and time can be assigned individually to a proper lower limit value and improper upper limit value (or connection threshold value)) at which the corresponding information is checked.

In the embodiments above, the AP selecting agent 210 of the wireless communication terminal 200P reports a proper lower limit value and an improper upper limit value (or connection threshold value) to the access control server 100. In another one embodiment according to the present invention, the AP information reporting unit 211 of the AP selecting agent 210 calculates a connection recommended value to be described below directly from the proper lower limit value and an improper upper limit value (or connection threshold value) and reports the connection recommended value to the access control server 100 as the mutual communication property information. In the present embodiment, the AP information reporting unit 211, as in the previous embodiment, if a proper lower limit value about a currently connected AP is estimated, checks whether there exists an improper upper limit value that is estimated together with the proper lower limit value or estimated and stored in relation to the corresponding AP; if an improper upper limit value exists, the AP information reporting unit 211 calculates a connection recommended value from the two values. According to another one embodiment of the present invention, in case a connection threshold value is used, the AP information reporting unit 211 inquires whether a connection threshold value obtained from estimation with respect to the corresponding AP of the AP selecting unit 212; if an obtained connection threshold value is returned from the AP selecting unit 212, the AP information reporting unit 211 calculates a connection recommended value from the two values.

A method for calculating a connection recommended value can use Eq. [1] described below. Equation [1] expresses a method for the access control server 100 to obtain a connection recommended value from a plurality of proper lower limit values and improper upper limit values (or connection threshold values); therefore, the AP information reporting unit 211 uses the estimated unique “proper lower limit value” instead of “proper lower threshold representative value” appearing in Eq. [1] while the AP information reporting unit 211 uses the returned, unique “improper upper limit value” (or “connection threshold value”) instead of “improper upper threshold/connection lower threshold representative value”. If a connection recommended value is calculated, the AP information reporting unit 211 reports the calculated connection recommended value, identifier of the corresponding AP, and type information of the AP information reporting unit 211 (for example, model name) to the access control server 100 as mutual communication property information.

If an improper upper limit value has not been estimated or a pre-stored improper upper limit value does not exist (in another one embodiment according to the present invention, if no information about a connection threshold value is obtained from the AP selecting unit 212), the connection recommended value is not calculated but the proper lower limit value obtained previously can be reported as mutual communication property information. At this time, too, the mutual communication property information includes an indicator indicating inclusion of the proper lower limit value rather than the connection recommended value.

In the previous embodiment where the AP selecting agent 210 directly calculates and reports a connection recommended value, the access control server 100 constructs a property statistical table as shown in FIG. 13 and registers received mutual communication property information in the corresponding statistical table as a statistical element. In the embodiment of FIG. 13, different from the embodiment of FIG. 12 where a proper lower limit value and improper upper limit value (or connection threshold value) are registered individually, a recommended connection value 720 is registered for the corresponding terminal type of the corresponding AP. As in the embodiment of FIG. 12, information about a date and time at which the corresponding statistical element is received or measured can be registered in conjunction with the corresponding element. Meanwhile, if a proper lower limit value is received instead of a connection recommended value as mutual communication property information from the AP information reporting unit 211, the access control server 100 takes a default signal strength value, pre-stored after being obtained experimentally based on the corresponding terminal type and the corresponding AP and at which a low service speed (for example, 100˜200 kbps) is provided, as a value corresponding to an improper upper limit value (or connection threshold value) and calculates a connection recommended value from the value and a received proper lower limit value and registers the calculated connection recommended value for the statistical table of FIG. 13 as a statistical element. Depending on whether an embodiment according to the present invention uses an improper upper limit value or a connection threshold value, a different value can be used for the default signal strength value.

In another one embodiment according to the present invention, where the AP selecting agent 210 reports a proper lower threshold vale and improper upper limit value (or connection threshold value) as mutual communication property information, too, the access control server 100 can construct and manage a property statistical table as shown in FIG. 13. In the present embodiment, if a proper lower limit value and improper upper limit value (or connection threshold value) are all included in the received mutual communication property information, the access control server 100 calculates a connection recommended value from both values as described earlier and registers the connection recommended value for the corresponding property statistical table. If the improper upper limit value (or connection threshold value) is not included in the mutual communication property information, a default signal strength value obtained experimentally and stored beforehand as described above is used as an improper upper limit value (or connection threshold value) and a connection recommended value is calculated from the default signal strength value and a proper lower limit value contained in the mutual communication property information; and registered in the corresponding statistical table.

In the embodiments of FIGS. 12 and 13, statistical tables are classified according to individual APs and mutual communication property information reported from a wireless communication terminal is registered in the property statistical table of the corresponding AP; in another embodiment according to the present invention, however, statistical tables can be classified according to the terminal type and mutual communication property information reported can be registered in a property statistical table of the corresponding terminal type in association with the corresponding AP.

The access control server 100 which constructs and manages terminal types and property statistical tables of APs according to one of schemes described in the embodiments above stores the whole property statistical tables in a database; if the access control server 100 receives a request for AP reference information from an arbitrary wireless communication terminal, the access control server 100 constructs AP reference information about the corresponding terminal type based on the statistical tables in the database and provides the constructed AP reference information. In what follows, the aforementioned operation of the access control server 100 will be described in more detail.

If a wireless communication terminal 200R comprising constituting elements illustrated in FIGS. 2 and 3 is enabled to access the Wi-Fi network 1 as the wireless communication terminal 200R enters p1 one of service zones 1₁,1₂,1₃ having a mutually overlapping area 1ₒᵥ and allowing access to the Wi-Fi network 1 within the service area of the cellular network 10 as shown in FIG. 1, the operating system 200a generates a “Wi-Fi available event” for currently detected APs (in the example of FIG. 1, AP1, AP2, and AP3 which form Wi-Fi zones 1₁, 1₂, and 1₃ respectively). This event includes identification information about each AP currently detected, for example, MAC address.

In one embodiment according to the present invention, the AP selecting agent 210 can disable a search for a Wi-Fi network performed by the operating system 200a and request enabling the search when it is needed. The time point at which the search is needed includes when the lock state of the wireless communication terminal 200R is released; regular time intervals according to a search period whose duration is adaptively varied according to a current state or time zone; when a particular application is activated; when a network access request is raised from an arbitrary application; when a response according to a request compliant with communication protocol is such that data to be received requires higher bandwidth more than a predetermined level; or when a request for entering a Wi-Fi network is received from an external server. In the present embodiment, if it approaches the time point described above, the AP selecting agent 210 enables the Wi-Fi search function of the operating system 200a and makes the search result delivered to the AP selecting unit 212 which has already registered for receiving the “Wi-Fi available event”. If accessible APs are found after the Wi-Fi network search and APs belonging to the history information about previous access are included, the operating system 200a can directly access the corresponding AP without generating an event. Therefore, the AP selecting agent 210, to ensure generation of an event, can read out “AP access history information” from the operating system 200a and store it as a backup and request removal of the history information from the operating system 200a. In one embodiment according to the present invention, the AP selecting agent 210 requests enabling the Wi-Fi network search and after a predetermined time delay since the request, notifies the AP selecting unit 212 of the request.

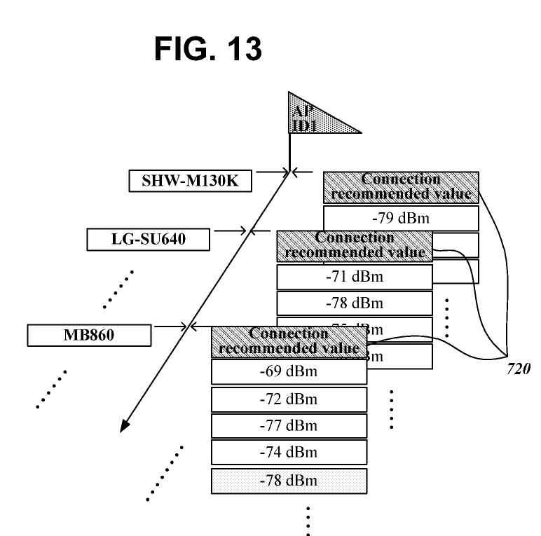

If the “Wi-Fi available event” is generated, the AP selecting unit 212 receives the event and reads identification information of each AP accompanying the event. Instead of following a method based on event generation, at the time of receiving a request notification for enabling the Wi-Fi network search from the AP selecting agent 210, the AP selecting unit 212 can request and receive from the operating system 200a identification information about each AP currently searched. If identification information of each AP is checked, as shown in FIG. 15, an AP reference information requisition including the checked identification information 811 and type information of the wireless communication terminal 200R, for example, a model number 812 is constructed S55 and is transmitted to the access control server 100, S56. Transmission of the AP reference information requisition to the access control server 100 is carried out through a communication socket generated by the AP selecting unit's 212 requesting from the operating system 200a with respect to the cellular network 10 and directed to the access control server 100. At this time, data to be transmitted is composed in the form of TCP packet and encoded by the cellular codec 21b and modulated by the cellular modem 21a and transmitted to a nearby base station in the form of a wireless signal; in this way, the data is delivered to the access control server 100 through data communication nodes constructed in the cellular network 10.

The previous embodiment assumes that a server receiving a report about mutual communication property information and a server receiving an AP reference information requisition are all implemented in the single access control server 100. However, in another embodiment according to the present invention, as described later about the structure of the access control server 100, they can be installed as multiple servers having IP addresses independent of each other. Therefore, in this case, the AP information reporting unit 211 and the AP selecting unit 212 maintain different addresses (for example, URLs) of the corresponding servers for reporting or requesting information.

The access control server 100 receiving the AP reference information requisition as composed in FIG. 15 checks a connection recommended value for each AP included in the requisition and constructs AP reference information as follows. The connection recommended value refers to an approximate minimum limit value of signal strength estimated to ensure a wireless communication terminal to have a reliable communication speed while communicating with the corresponding AP. First, APs are selected one by one from the AP list 81 included in the requisition and a particular statistical table related to the selected AP is designated from the statistical tables already prepared in the form of a database as shown in FIG. 12. Then, a connection recommended value about terminal type information specified in the requisition is calculated from the designated statistical table.

In one embodiment according to the present invention, the access control server 100, instead of calculating a connection recommended value of each AP specified in the requisition related to the corresponding terminal type at the time of receiving the AP reference information requisition, can calculate and record the connection recommended value beforehand from each terminal type and the corresponding statistical elements registered for each AP. In the present invention, when mutual communication property information is reported from the AP selecting agent 210 executed in an arbitrary wireless communication terminal and the mutual communication property information is registered as one statistical element in a property statistical table designated by the information or at particular time in a day, for example, four a.m., the access control server 100 searches each statistical table and based on statistical elements registered in the corresponding statistical table, calculates and records a connection recommended value as described below. In the present embodiment, if an AP reference information requisition is received afterwards, pre-recorded connection recommended values are searched for with respect to the terminal type and each AP specified in the requisition; and constructs AP reference information by using the values searched.

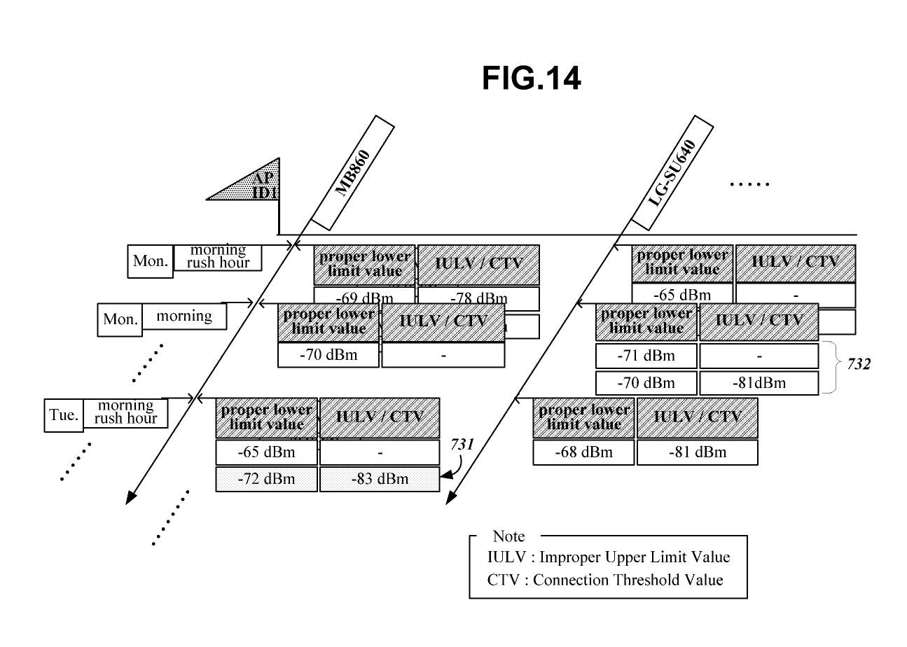

FIG. 16 illustrates an example where a connection recommended value about the corresponding terminal type is calculated from a statistical table designated by an AP among statistical tables in which mutual communication property information is registered as shown in FIG. 12 and for the purpose of understanding, graphically describe the distribution of individual statistical elements, namely, measurement values (proper lower limit value, improper upper limit value (or connection threshold value)) registered in the designated statistical table. The access control server 100 determines a valid range for statistical elements related to the corresponding terminal type of the designated statistical table according to the respective groups (a proper lower limit value group 901, improper upper limit value (or connection threshold value) group 902). The valid range can be determined to accommodate the range of all the measurement values or only the range of those measurement values excluding the measurement values, for example, beyond 1.5σ (where σ is a standard deviation of measurement values), 2σ or 3σ distance in the distribution of measurement values. The access control server 100, if a valid range is determined for each group 901, 902, obtains a representative value from target measurement values belonging to the range S57a. The representative value can be obtained by a media value or an average value of target signal strength values falling into the valid range determined. Differently, a median value of an interval with the largest frequency when the valid range is partitioned into intervals of a fixed size can be taken or an average value can be calculated. Similarly, the representative value can also be determined by assigning a larger weight to the newest registered measurement value. For example, in case an average value is obtained only for those measurement values within the valid range which includes measurement values whose elapsed time is within a month, a partial average value about each time interval (for example, within one hour, six hours, 24 hours, a week, or a month) partitioned according to elapsed time and the number of elapsed days is obtained; each partial average value is multiplied sequentially by the weight value of 0.6, 0.2, 0.1, 0.07, and 0.03; and the partial average values multiplied by the corresponding weight values are summed together to be used as the representative value of the corresponding group Also, the weight applied to the partial average value can be set up adaptively according to the number of statistical elements belonging to the corresponding time interval. For example, if the number of statistical elements belonging to the time interval within one hour does not reach up to the number of samples within an appropriate range, the value of 0.6 in the above example can be set to 0.4 whereas the number of statistical elements exceeds the number of samples within the appropriate range, the value of 0.6 can be set to 0.8, after which an average value is calculated. At this time, the weight values for other time intervals are decreased or increased appropriately so that the sum of the whole weight values equals to 1.

The access control server 100, after calculating a representative value for all the groups 901, 902 of measurement values, determines a connection recommended value by using the calculated, individual representative values. In one embodiment according to the present invention, the connection recommended value AccRecSS can be determined as shown in Eq. [1]

AccResSS=α×(proper lower threshold representative value)+β×(improper upper threshold/connection lower threshold representative value), where α+β=1, and 0<α, β<1. Eq. [1]

In Eq. [1], α and β are selected by appropriate values within a range satisfying the above conditions; and can be adaptively modified based on a result obtained by experimentally applying a connection recommended value obtained by the selected value and can be applied to Eq. [1]. In one embodiment according to the present invention, 0.5 is assigned to each of α and β.

In calculating a connection recommended value of each AP with respect to the corresponding terminal type from a statistical table containing measurement values as described above, there may be a case where measurement values for an improper upper limit value (or connection threshold value) are not registered in the corresponding statistical table. In this case, the access control server 100 can calculate the connection recommended value by substituting the “representative value of improper upper limit values/connection threshold values” of Eq. [1] for the default signal strength value pre-stored by obtaining experimentally from the corresponding terminal type and AP as described above.

The connection recommended value calculated as described above has signal strength lower than the average of a proper lower limit value group 901.

In the case of the embodiment where mutual communication property information is registered in a property statistical table as shown in FIG. 13, the access control server 100 obtains a representative value from the distribution of connection recommended values registered for the corresponding terminal type in the property statistical table which is specified for each AP included in a received AP reference information requisition, as shown in FIG. 13. To obtain the representative value, as described in the previous embodiment, a valid range of connection recommended values registered as a statistical element is first determined and within the valid range, a median value, average value, or an average value obtained by incorporating weight values according to elapsed time is taken.

In the embodiments according to the present invention, by taking account of the date and time at which mutual communication property information and the date and time at which the AP reference information requisition is received, only part of statistical elements registered in the corresponding statistical table can be used for calculating a connection recommended value. To this end, the access control server 100, as shown in FIG. 14, divides day/time zone in a proper way and constructs a property statistical table for each AP such that measurement values are assigned according to the divided day/time zone. Now, if mutual communication property information is received from the AP selecting agent 210 of wireless communication terminals, the access control server 100 registers the mutual communication property information as a statistical element in the divided day/time zone corresponding to the date and time at which the information is obtained or received. The example of FIG. 14 illustrates a case where, as the mutual communication property information 711 of FIG. 12 which is received from a terminal of model name “MB860” with respect to the AP of identifier ID1 is reported during rush hour of Tuesday (for example, 7˜9 a. m.) and registered or the measurement date and time recorded in the reported mutual communication property information belongs to the morning rush hour of Tuesday, one statistical element 731 matched to Tuesday morning rush hour is registered as the measurement value.

As shown in FIG. 14, in the embodiment where statistical elements are divided according to day/time zone and a property statistical table is thus constructed/managed, if the access control server 100 receives an AP reference information requisition, the access control server 100 first figures out to which day/time zone, which is the classification criterion, the date and time of receiving the requisition corresponds; and calculates a connection recommended value by using statistical elements belonging to the matched day/time zone, namely, mutual communication property information as described above. For instance, if an AP having an identifier ID1 is recorded in an AP reference information requisition received from a wireless communication terminal of a model name “LG-SU640” and the requisition has been received in Monday morning (for example, 9 a. m.˜12 p. m.), those statistical elements 732 registered in the corresponding day/time zone of FIG. 14 are used for calculating a connection recommended value. Regarding the statistical elements belonging to the matched day/time zone, all of the elements are not necessarily used but a valid range is determined beforehand and only the statistical elements belonging to the valid range can be used as described above.

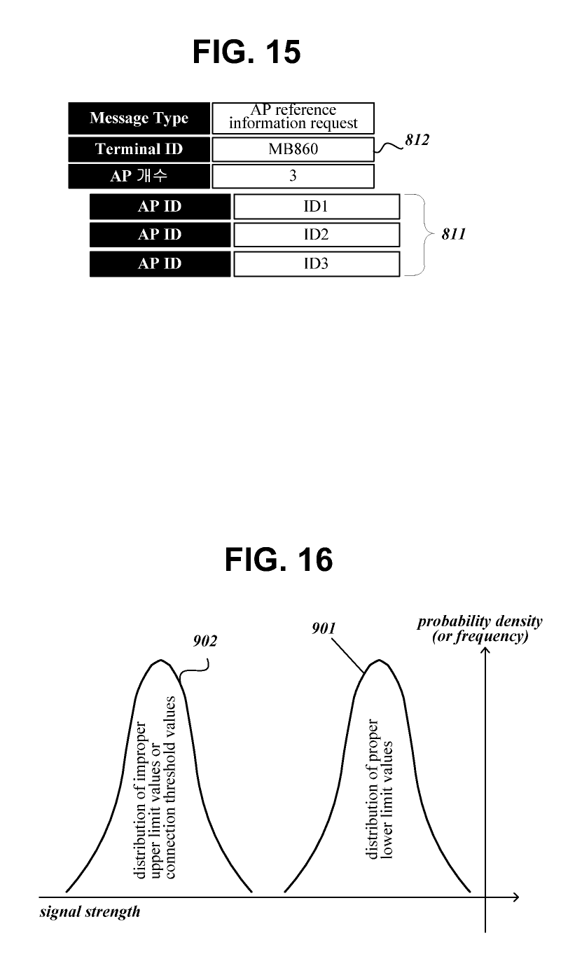

Once the access control server 100 obtains a connection recommended value with respect to each AP specified in a received AP reference information requisition as described above from statistical elements (in the embodiment of FIG. 12 or FIG. 14) of proper lower limit values and improper upper limit values (or connection threshold values) related to the terminal type specified in the requisition or from statistical elements of the connection recommended value, it constructs AP reference information containing the above values S57b. The AP reference information constructed can include the number of APs 1001 specified or can include the calculated connection recommended value 1011 for each AP as illustrated in FIG. 17. In one embodiment according to the present invention, if the number of APs is multiple at the time of constructing the AP reference information, the APs can be listed up according to the magnitude of its calculated connection recommended value. For example, FIG. 17 illustrates a case where the APs are specified in the ascending order of connection recommended values.

In another one embodiment according to the present invention, if other APs adjacent to the APs specified in a received AP reference information requisition are found from location information registered in the AP database pre-constructed for individual APs operated by communication service providers, the access control server 100 calculates a connection recommended value for the other APs (APs not specified in the AP reference information requisition) according to the method described above from proper lower limit values and improper upper limit values (or connection threshold values) registered in the property statistical table of the corresponding AP with respect to the corresponding terminal type or from connection recommended values registered with respect to the terminal type and constructs AP reference information which additionally specifies the newly calculated connection recommended value. The access control server 200 determines whether other APs are adjacent to at least one AP specified in a received AP reference information requisition based on the following method. The access control server 100 searches the AP database having a binary search structure for pre-registered location coordinate information of each AP specified in the received AP reference information requisition; determines median coordinates from the searched location coordinates (if the received AP reference information requisition contains only one AP, the coordinates of the AP becomes the median coordinates); searches the pre-constructed AP database for other APs located within a predetermined radius from the median coordinates; and determines those APs within that radius as APs adjacent to the AP.

It may be the case that, in obtaining a connection recommended value for each AP specified in a received AP reference information requisition by the access control server 100, the connection recommended value is not registered in the property statistical table as measurement values used for calculating the connection recommended value are not reported for an arbitrary AP specified in the requisition. A connection recommended value for such an AP (in what follows, it is called a “unregistered AP”. The meaning of “unregistered” includes a case where only statistical elements designated “non-use” as registered statistical elements, if they ever exist, correspond to particular conditions, for example, “excess of limitation of registration period” are registered, not to mention the case where no statistical elements are registered for the corresponding AP) uses a reference value of a different AP(s), namely, connection recommended value for constructing AP reference information. A specific method for using a reference value will be described in detail in an embodiment where a reference value, namely, connection recommended value is determined in a wireless communication terminal, which is another embodiment according to the present invention.

Meanwhile, the access control server 100, in order to reflect the latest mutual communication property and so on about each AP (or type of each terminal) in a property statistical table constructed by using mutual communication property information received from the individual AP selecting agents 210 of a wireless communication terminal, removes from the property statistical table statistical elements, namely, measurement values prior to predetermined time. To this purpose, a measurement value of each statistical table is recorded in conjunction with date and time at which the value is obtained (measured or received) as described above; based on the date and time, a statistical element passing one week, ten days, or one month, for example, is removed from the property statistical table.

The access control server 100 transmits AP reference information constructed as described above to the wireless communication terminal 200R in response to the AP reference information requisition received previously S58. The AP reference information transmitted from the access control server 100 goes through the cellular modem 21a and cellular codec 21b of the wireless communication terminal 200R and reconstructed into data to be delivered to the operating system 200a; the operating system 200a identifies a session by analyzing the corresponding data in the session layer and delivers the identified session to the AP selecting unit 212.

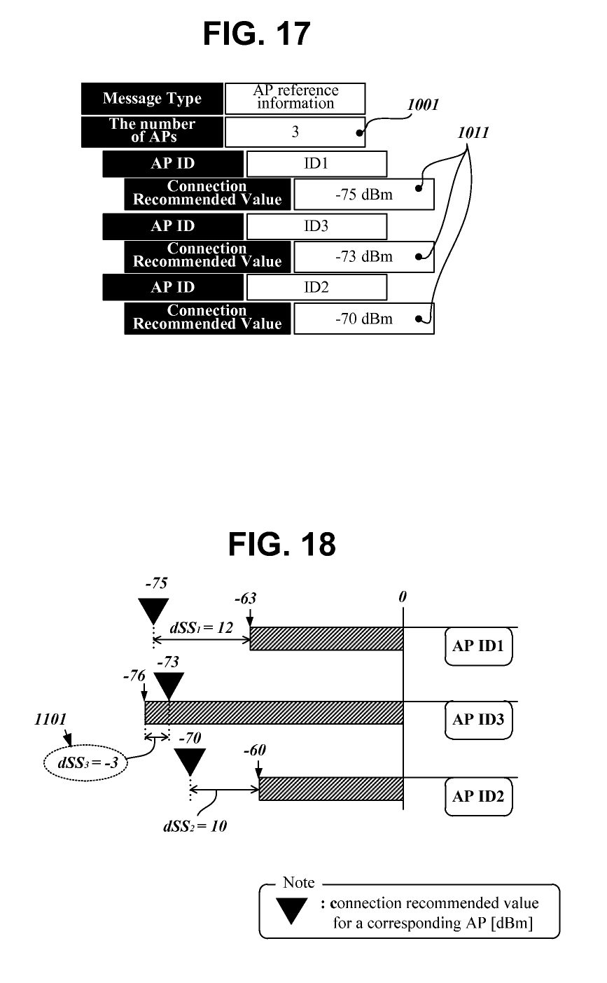

If the AP selecting unit 212 of the wireless communication terminal 200R receives the AP reference information transmitted by the access control server 100, the AP selecting unit 212 requests a search for nearby APs from the operating system 200a and checks identification information about APs whose signals are detected and information about signal strength and so on S59a. In one embodiment according to the present invention, if information about signal strength of the corresponding AP and so on is checked in addition to the identification information of each AP and is stored as AP search information to prepare the AP reference information requisition, the stored AP search information can be checked without performing an AP search after receiving the AP reference information. Regarding the checked signal strength of each AP, as shown in FIG. 18, relative strength (dSSₖ=“checked signal strength value”−“connection recommended value”) with respect to the connection recommended value specified in the received AP reference information is figured out. The relative strength can assume a negative value if the checked signal strength is smaller than the connection recommended value 1101. If relative strength dSSₖ is obtained as described above, connection priority of each AP located within signal detectable range (or within the AP search information stored) is determined (as described below, some APs are excluded from connection; “determination of connection priority of APs” in the present document is used to embrace the meaning of determining whether to exclude an AP from establishing connection) according to the magnitude of the relative strength; while AP identification information is provided according to the determined connection priority, connection to the corresponding AP is requested from the operating system 200a; thus, the initial connection to the Wi-Fi network 1 of the corresponding zone or switching between APs is carried out S59b. Regarding a connection-requested AP, the operating system 200a requests allocation of a connection IP address from the corresponding AP; if the connection IP address is assigned successfully according to the request, “connection success” is notified to the AP selecting unit 212 whereas “connection failure” is notified.

In one embodiment according to the present invention, if the AP selecting unit 212 is notified of “connection success” from the operating system 200a, it searches for nearby APs at a particular time point since the notification and constructs an AP reference information requisition for the searched APs as described above and transmits the AP reference information requisition to the access control server 100 through the Wi-Fi network 1. Regarding AP reference information received according to the transmission of the requisition, it can be stored and used later when connection to the Wi-Fi network 1 is released and connection to the Wi-Fi network 1 is attempted again.

According to the previous embodiment of the present invention, the AP with the highest signal strength (the AP of ID2 in FIG. 18) among nearby APs searched is not accessed first; instead, accessed first is the AP (ID1 of FIG. 18) showing a much larger difference of signal strength as its connection recommended value is relatively lower though it may not be the AP showing the highest signal strength. This may be because the wireless communication terminal 200R type exhibits a statistically better property for communication with the AP of ID1 rather than the AP of ID2, the AP of ID1 can provide a service of the same quality even though the communication conditions for the AP of ID1 are relatively inferior.

In one embodiment according to the present invention, in case a connection attempt performed sequentially to APs according to the magnitude of relative signal strength dSSₖ calculated as described based on individual signal strength values of nearby APs is not successful, the corresponding APs which show a negative value for the relative strength may not be considered for attempting connection. In other words, as described above, at the time of determining a connection priority of each AP for establishing connection, such AP (in the example of FIG. 18, the AP of ID3) that shows a negative relative strength value is excluded from the connection establishment. If all the relative strength values dSSₖ of currently nearby APs calculated based on connection recommended values about individual APs within received AP reference information show a negative value, the AP selecting unit 212, instead of attempting connection switching to the Wi-Fi network 1, maintains the connected state to a current wireless communication network, namely, the cellular network 10.

In case a connection threshold values is used instead of an improper upper limit value according to an embodiment of the present invention, the AP selecting unit 212, if the number of current nearby APs is single and relative strength dSSₖ of the AP show a negative value, relative strength of the AP or part of currently nearby APs reveal a positive value; however, in case all the connection attempts to the APs fail, connection can be attempted to each of the remaining APs showing a negative value to measure a connection threshold value as described earlier. If connection to the corresponding AP is established from the above connection attempt for measuring a connection threshold value, the connection state is not maintained but re-switching to the cellular network 10 can be carried out. A method for calculating a connection threshold value according to the present invention is described as follows.

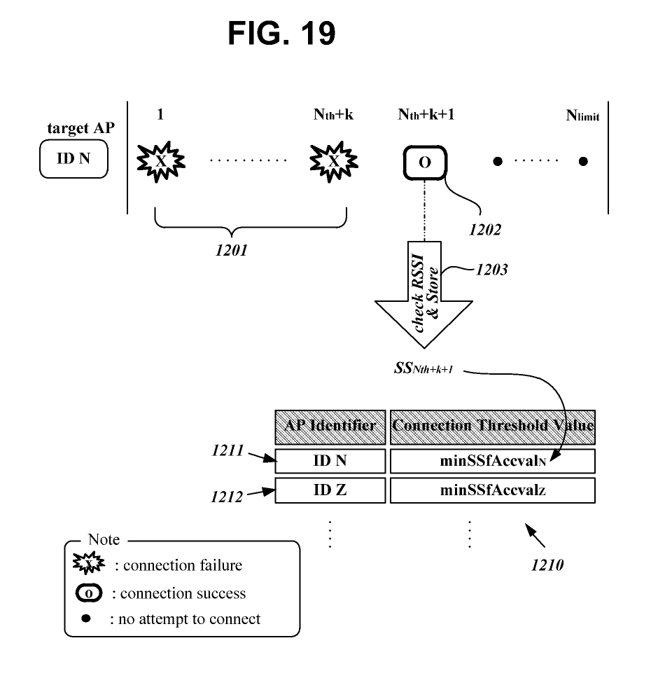

The AP selecting unit 212 attempts connection to the AP whose relative strength dSSₖ is a negative value repeatedly until connection is successfully established within a predetermined limiting number Nₗᵢₘᵢₜ of connection trials, for example, within 10 times. As shown in FIG. 19, if such a connection attempt fails repeatedly as many times as a predetermined limit value, for example, more than three times 1201, a signal strength value of the corresponding AP at the corresponding time point is requested from the operating system 200a and checked 1203; the checked signal strength value SS_{Nth+k+1} is stored as a connection threshold value minSSfAccval together with identification information of the corresponding AP 1211. At this time, information about a current date and time can be checked from the operating system 200a and stored together with the signal strength value checked.

In one embodiment according to the present invention, at each time of attempting connection, signal strength at the corresponding time point is checked; and the signal strength value at the time of connection success is determined and stored as a connection threshold value as far as the signal strength value checked at the time of connection success is higher than the signal strength value at the time of a previous connection failure. For example, in the example of FIG. 19, if each of the signal strength values SS1, SS2, . . . , SS_{Nth+k} when connection attempt fails 1201 is lower than the signal strength SS_{Nth+k+1} checked when connection attempt succeeds 1202, the signal strength value SS_{Nth+k+1} when connection attempt succeeds is stored as a connection threshold value.

In case there exists another AP whose relative strength dSSₖ shows a negative value, the operation above is carried out in the same way for the AP and stored as a separate entry 1212. If there exists information about the corresponding AP stored prior to the connection lower threshold-related information 1210 stored as shown in FIG. 19, the AP selecting unit 212 overwrites the information about the corresponding AP by using a signal strength value currently checked. The connection lower threshold-related information 1210 stored as described above is provided when the AP information reporting unit 211 request for a connection threshold value as described above. The AP selecting unit 212, after reporting the stored connection lower threshold-related information 1210 to the AP information reporting unit 211, removes the information 1210.

In case the connection threshold value request from the AP information reporting unit 211 contains AP identification information according to a different embodiment of the present invention, the AP selecting unit 212 extracts only the connection threshold value (or together with information about a date and time at which the threshold value is checked) stored with respect to the AP and selectively removes the entry related to the corresponding AP.

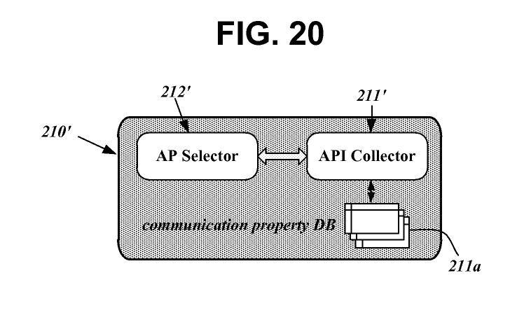

In the embodiments above, the AP selecting agent 210 provides mutual communication property information associated with APs to an external server and receives from the server AP reference information described earlier and uses the AP reference information for determining connection switching of a wireless communication network or selecting an AP. In a different embodiment according to the present invention, mutual communication property information is determined from a communication property associated with an arbitrary AP, namely, the property at the time of using a data service or the property found during a connection process; the mutual communication property information is collected by a wireless communication terminal itself; and a connection recommended value is calculated from the collected mutual communication property information and is used for determining connection switching of a wireless communication network or determining an AP to be connected. To this purpose, the AP selecting agent can be constructed as shown in FIG. 20. As shown in the figure, the AP selecting agent 210′ comprises an AP information collecting unit 211′ and an AP selecting unit 212′; the AP selecting agent 210′ is implemented or installed in the wireless communication terminal 200P, 200R in the same way as the AP selecting agent 210 described above and is carried out by the main controller 20 based on the operating system 200a.

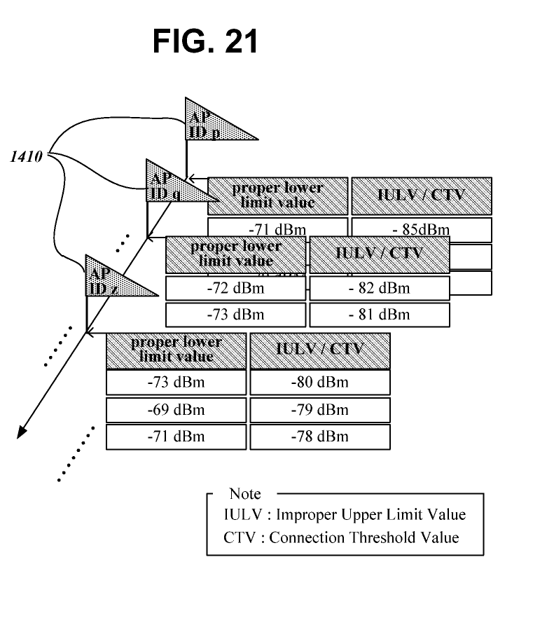

In the embodiment according to FIG. 20, the AP selecting unit 212′, different from previous embodiment, requests reference information about APs from the AP information collecting unit 211′ rather than from a remote server. Except for the difference in the request operation above, the AP selecting unit 212′ carries out the same operation as the AP selecting unit 212 as in the embodiments described earlier. Therefore, the current request also includes identification information 811 about nearby APs as illustrated in FIG. 15 but does not include terminal type information 812. In response to the request, to construct AP reference information as described above, the AP information collecting unit 211′ constructs a property statistical table 211a comprising mutual communication property information estimated by the method described above or obtained (from the AP selecting unit 212′). The property statistical table constructed by the AP information collecting unit 211′ can take any one of the structures shown in FIGS. 12 to 14. In the structure, since terminal type is concerned only for the terminal itself, it is not classified. In other words, the property statistical table 211a constructed by the AP information collecting unit 211′ can have such a structure that registration groups are classified according only to the AP identification information 1410 as shown in FIG. 21 in the embodiment where a proper lower limit value and an improper upper limit value (or connection threshold value) are registered separately from each other. In the case where the date/time zone is considered in the property statistical table as shown in FIG. 14, the statistical table can be further divided by the items according to the date/time zone. Although the access control server 100 in the previous embodiments reflects the mutual communication property information in the property statistical table even when the improper upper limit value (or connection threshold value) is not included in the mutual communication property information, the access control server 100 in the present embodiment deals only with the case where both the proper lower limit value and the improper upper limit value (or connection threshold value) are obtained and reflects the two values or a connection recommended value determined from the two values in the property statistical table.

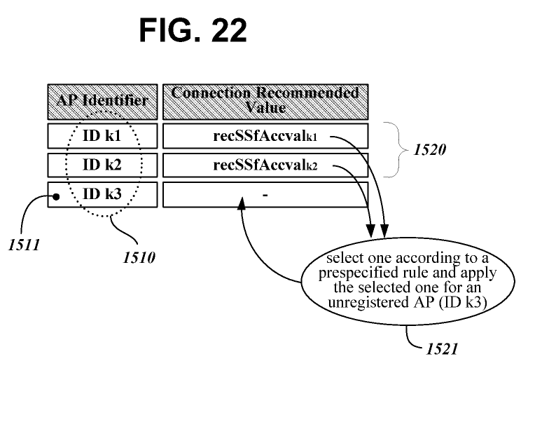

The AP information collecting unit 211′, receiving from the AP selecting unit 212′ a request for reference information of APs, calculates a reference value, which is a connection recommended value, from statistical elements registered in the property statistical table 211a being constructed by the AP selecting unit 212′ by using the same method used by the access control server 100 in the previous embodiment for each of APs included in the request; prepares AP reference information by including each reference value calculated as described above in conjunction with each AP included in the request and provides the AP reference information to the AP selecting unit 212′. Meanwhile, in the present embodiment, since the number of APs registered in the property statistical table 211a is somewhat limited, it is commonly observed that the APs contained in the request for reference information of APs are unregistered. Regarding the unregistered APs, the AP information collecting unit 211′ adopts the reference value calculated for other registered APs. FIG. 22 provides graphical illustration of adopting a reference value; in case the AP 1511 identified by “ID k3” is a unregistered AP among APs 1510 contained in a received AP reference information request, a connection recommended value calculated for other registered APs is adopted as it is for the unregistered AP. As shown in FIG. 22, in case the number of connection recommended values that can be adopted is multiple 1520, one from the multiple values is selected and used for the unregistered AP 1521.

When one from among a plurality of connection recommended values is adopted, it can be chosen by taking account of the number of measurement values registered in the statistical table from which the recommended values are calculated or registration date and time of the recommended value. For example, in the case of a plurality of connection recommended values, a connection recommended value calculated from the statistical table of an AP which has the largest number of registered statistical elements can be chosen and applied for unregistered APs. Similarly, a connection recommended value calculated from the property statistical table of an AP, which contains the most recently registered statistical elements can be chosen to be applied for unregistered APs.

In another one embodiment according to the present invention, to adopt a reference value, a plurality of connection recommended values 1520 calculated from registered statistical elements or an arithmetic average value of connection recommended values determined for individual APs registered in the property statistical table 211a can be obtained to be applied as a connection recommended value for an unregistered AP 1511. In one embodiment according to the present invention, instead of using the arithmetic average value, a weighted average value can be used, where a relatively large weight value is assigned in proportion to the number of the corresponding statistical elements to the connection recommended value determined for the associated AP.

FIG. 22 is intended only for describing that a connection recommended value calculated for other APs can be adopted for an unregistered AP and this does not indicate that the AP adopting the connection recommended value is not necessarily limited to the values contained in the AP reference information request. In other words, if an unregistered AP is included in a received AP reference information request, the AP information collecting unit 211′, not limiting the other APs included in the AP reference information request but considering all the APs constructed into the form of a statistical form, can apply the connection recommended value calculated from the statistical table containing the largest number of statistical elements or the newest statistical elements for the connection recommended value about the unregistered AP.

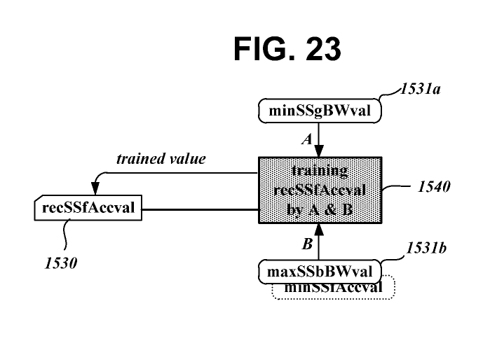

In another one embodiment according to the present invention, a separate variable is assigned to the connection recommended value to be applied for an unregistered AP and the variable's value is obtained adaptively. In the present embodiment, as shown in FIG. 23, if a proper lower limit value 1531a and an improper upper limit value 1531b (or connection threshold value) are all obtained for an arbitrary AP, the AP information collecting unit 211′ trains 1540 the property variable 1530 containing the initial value of the connection recommended value by using the two values obtained. Such training 1540 of the connection recommended value is carried out continuously at each time of using a service through a different AP. The method of training 1540 a connection recommended value can be carried out by using a method for obtaining an average value of connection recommended values due to measurement values (a proper lower limit value and an improper upper limit value (or connection threshold value)) or by using a method for obtaining a weighted average by assigning a large weight to a newer measurement value.

In this way, if there is an unregistered AP among APs specified in a request for AP reference information received from the AP selecting unit 212′, the value of the property variable 1530 trained continuously is included in the AP reference information to be constructed as a connection recommended value for the AP.

In one embodiment according to the present invention, all of the measurement values obtained from an AP may not be applied for training 1540 the property variable 1530. For example, the AP information collecting unit 211′ records the number of connections to an AP each time connection is attempted for the AP and if the number of connections exceeds a predetermined reference value (for example, N times for a predetermined time period), the measurement values obtained from the corresponding AP may not be used for training 1540 the property variable 1530. This may be intended for applying the value of the trained property variable 1530 as a default connection recommended value for an AP with low connection frequency. In one embodiment according to the present invention, measurement values obtained from the corresponding AP are not registered in the property statistical table until the number of connections to the corresponding AP exceeds the predetermined reference value.

In another one embodiment according to the present invention, the default connection recommended value to be used for an unregistered AP can assume multiple values rather than a single value. For example, while assigning a property variable to the APs having the same SSID and training the property variable as described above, for the APs of a particular SSID at some time point in question, the property variable value assigned to the group of the particular SSID can be used. In the present embodiment, for each SSID already known to have more than a predetermined number of APs, a property variable is assigned for a default connection recommended value and another property variable can be assigned for the default connection recommended value to be used for a group of APs to which an already-known SSID or unknown SSID having the limited number of APs is assigned.

In the previous embodiments, the AP selecting unit 212, 212′ directly reflected relative strength dSSₖ between a connection recommended value contained in the received AP reference information and received signal strength checked for currently nearby APs; and according to the magnitude of the relative strength, connection switching or priority of APs for connection attempts has been determined. In another one embodiment according to the present invention, the relative strength dSSₖ obtained as described above is compensated by considering real-time communication environment factors and then the compensated relative strength is used for determining priorities of APs. In one embodiment according to the present invention, mutual overlap in the channel used by nearby APs currently detected for communication, for example 13 channels allocated in the Wi-Fi signal band, is regarded as the real-time communication environment factor. In other words, for the AP whose communication channel overlaps that of another AP, the connection recommended value specified in the received AP reference information is compensated to have a still higher value. This is for compensating slight degradation of service quality intended by the original connection recommended value due to channel overlapping.

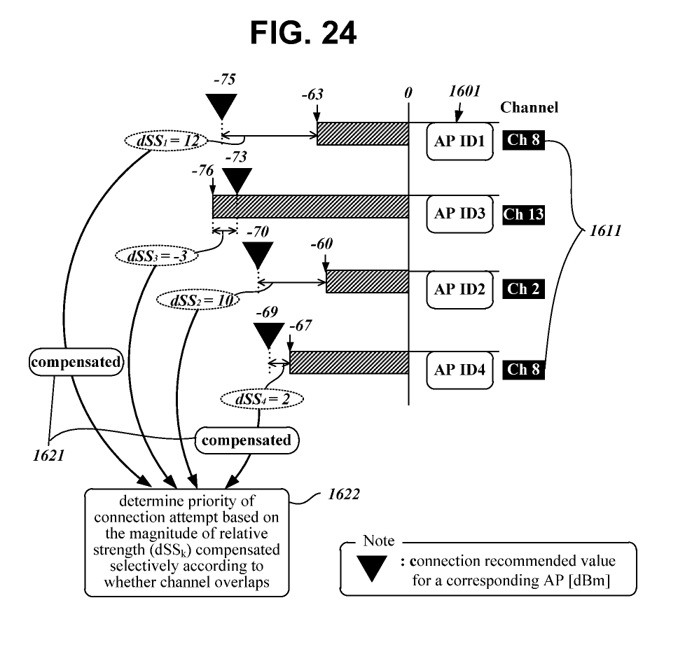

The AP selecting unit 212, 212′ checks from information about nearby APs obtained by requesting from the operating system 200a whether there exist APs using the same channel. If no APs are found to share the same channel, the operation described in the previous embodiment is carried out as intended; on the other hand, for the APs mutually overlapping with each other, the aforementioned relative strength dSSₖ calculated for overlapping APs is compensated by taking the corresponding signal strength into account. For example, as shown in FIG. 24, if the AP 1601 which show the largest relative strength dSSₖ shares the same channel with another AP 1611, relative strength dSS₁ for the corresponding AP 1601 is compensated by a predetermined method. The predetermined method can be implemented as expressed in Eq. [2].

Compensated dSSₖ=original dSSₖ−δ·f(x) {where δ is an adjustment coefficient, x is signal strength of another overlapping AP, f is a function(for example, 1st order function, log function, and so on)} Eq. [2]

In the Eq. [2], the function f and δ can be determined by experimentally analyzing noise effect due to signal overlapping.

In compensating the relative strength dSSₖ, the case where the number of overlapped channels is multiple can also be included. For example, if the number of APs with overlapping channels is two, Eq. [2] can be modified as follows.

Compensated dSSₖ=original dSSₖ−{δ₁·f(x₁)+β₂·f(x₂)−ζ·f(x₁)·f(x₂)}, Eq. [2′]

where ζ is a coefficient reflecting an associative property of multiple signal strength values.

Instead of using Eq. [2′], by taking account only of the highest signal strength among signal strength values exhibiting channel overlapping, the original relative strength dSSₖ can be compensated through Eq. [2]. Also, according to a different method not described in the present document, the relative strength dSSₖ can be compensated more properly be taking account of a noise effect due to overlapping signals.

Therefore, the AP selecting unit 212, 212′, once nearby APs are checked as in the example of FIG. 24, the relative strength dSS₁, dSS₄ obtained respectively for the APs having an identification number ID1 and ID4 are compensated 1621 according to a given method, for example, according to the rule of Eq. [2] and determines 1622 priority of each AP for connection attempt by comparing the compensated values with relative strength dSS₂, dSS₃ obtained for the APs having an identification number ID2 and ID3. If, in the example of FIG. 24, relative strength compensated for the AP 1601 of the identification number ID1 is less than 10, the AP with the highest priority for connection attempt will be the AP having the identification number ID2.

Unless the various embodiments described so far are not compatible with each other, the embodiments can be properly chosen in various ways and then combined to achieve the concept and idea of the present invention.

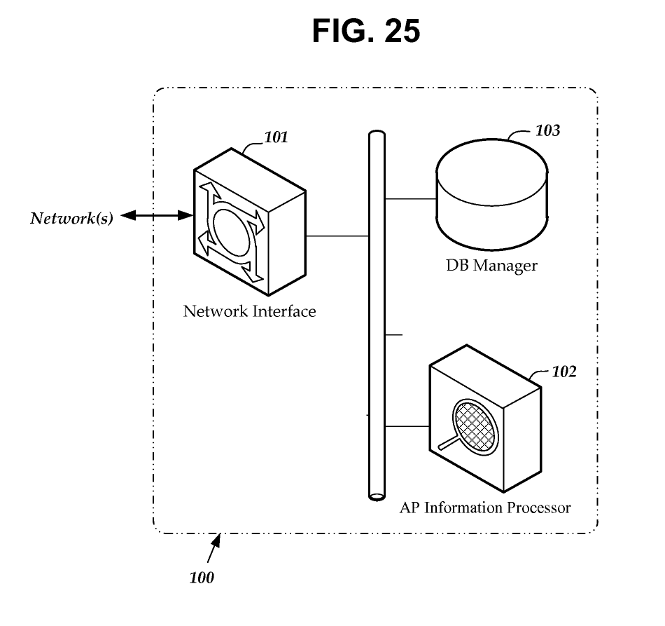

The access control server 100 described in the previous embodiments can comprise, as shown in FIG. 25, a network interface 101, an AP information processor 102, and a DB manager 103. The access control server 100 can be realized as a single computing device or a plurality of computing devices implementing individual constituting elements and independent of each other. In case the constituting element is implemented in the form of an independent computing device, for example, a server, a dedicated line or network is used to connect the constituting elements with each other and mutual communication is established by employing a relevant network security communication protocol. The individual constituting elements illustrated in FIG. 25, namely, the network interface 101, AP information processor 102, and DB manager 103 are supposed to carry out the operations described above in cooperation with each other, which are carried out by the access control server 100 in various embodiments.

The network interface 101 carries out communication with a wireless communication terminal 200P, 200R through a communication node connected to the cellular network 10 and/or Wi-Fi network 1; receives mutual communication property information and AP reference information requisition from the communication; delivers them to the AP information processor 102; and carries out the operation of transmitting them to the corresponding terminal in response to the requisition if AP reference information is received from the AP information processor 102. Also, the network interface 101 manages logical objects for communication purposes such as sockets and/or sessions to provide AP reference information to a particular wireless communication terminal 200R transmitting the AP reference information requisition or a particular wireless communication terminal 200P transmitting mutual communication property information.

The AP information processor 102 assigns mutual communication property information received from the network interface 101 to one of pre-classified conditions (for example, day, holiday, time zone, and so on) according to the time point at which the mutual communication property information is received (or measurement date and time information included in the communication property information); delivers the determined condition information to the DB manager 103 together with the received mutual communication property information; and requests construction of a database. If the AP reference information requisition is received from the network interface 101, APs adjacent to the AP(s) specified in the AP reference information requisition are checked from the pre-constructed database. And pre-classified conditions are determined according to the time point at which the AP reference information requisition is received and the determined condition information is delivered to the DB manager 103 together with identification information of each of the AP specified and nearby APs thereof and terminal type information. Meanwhile, statistical elements registered with respect to the corresponding terminal type (or each AP) in the property statistical table associated with each AP (or the corresponding terminal type) are requested and if statistical elements (recommended lower limit values, improper upper limit value (or connection threshold value), or connection recommended values) or location information of storage space with which the statistical elements can be checked is received in response to this request, the AP information processor 102, as described in the previous embodiments, analyzes the statistical elements and calculates a connection recommended value about each AP, which is a reference value, and delivers to the network interface 110 the AP reference information containing the calculated connection recommended value with respect to each AP and requests transmission of the AP reference information to the wireless communication terminal.

The DB manager 103, with respect to the received mutual communication property information, constructs a database in the physical storage space managed by the DB manager 103 itself or adds the received mutual communication property information newly to a pre-constructed database according to the classification condition information delivered by the AP information processor 102; if classification condition information, AP identification information, terminal type information, and so on are received, the DB manager 103 designates the corresponding property statistical table from the received information, determines a valid range of statistical elements corresponding to the classification condition information, and delivers to the AP information processor 102 measurement values within the valid range or location information of storage space in which the measurement values can be accessed. And the DB manager 103, to ensure the latest mutual communication property to be included, carries out deletion operation and the like for those statistical elements which has passed a predetermined time period.

The previous embodiment described with reference to the structure of FIG. 25 is related to the case where the DB manager 103 of the access control server 100 classifies mutual communication property information according to the date/time zone conditions as illustrated in FIG. 14 and stores the mutual communication property information in the form of a database. Accordingly, information about classification conditions are delivered between the network interface 101 and the AP information processor 102 or between the AP information processor 102 and the DB manager 103. However, in case the classification conditions based on date/time zone are not used according to another embodiment of the present invention, information about the classification conditions is made not to be delivered among the constituting elements 101, 102, 103. In other words, if a property statistical table is designated by an AP and terminal type while mutual communication property information provided from wireless communication terminals does not contain information about acquisition date of the mutual communication property information or the network interface 101 does not record the reception date of the communication property information in the corresponding information, all the statistical elements within the property statistical table (or within a valid range) are used for calculating the connection recommended value.

In one embodiment according to the present invention, the AP information processor 102 can comprise a property information processor and a reference information processor, which are separate computing devices independent of each other. The property information processor carries out the aforementioned operation such as processing received mutual communication property information as described above and requesting constructing the property statistical table in the form of a database from the DB manager 103 while the reference information processor carries out the aforementioned operation such as finding nearby APs of an AP specified in the received AP reference information requisition and preparing AP reference information by using the statistical table implemented in the form of a database in the DB manager 103 with respect to the individual APs including the nearby APs found. In the present embodiment, the aforementioned functions and hardware resources required for the functions of the network interface 101, too, can be distributed across the property information processor and reference information processor implemented as separate computing devices independent of each other and realized in the form of a single body with the corresponding processor.

Among the network interface 101, AP information processor 102, and DB manager 103, to mutually link a request with a response due to information delivery, an information identifier contained in the request can be included in the response or a response can be made by adding response information to the request.

The embodiments of the present invention described above have been introduced for the purpose of illustration; therefore, it should be understood by those skilled in the art that modification, change, substitution, or addition to the embodiments is possible without departing from the technical principles and scope of the present invention defined by the appended claims.

1. A wireless communication terminal capable of accessing a plurality of heterogeneous networks including a wireless data network, comprising:
an information reporting unit configured to
determine a value of a first property signal strength based on data receiving speed during usage of a data service through an arbitrary access point of the wireless data network,
prepare mutual communication property information including at least the determined value or at least a third value determined from the determined value and a value of a second property signal strength, the mutual communication property information further including identification information of the arbitrary access point and type information of the wireless communication terminal, and
report the mutual communication property information to a remote server through one network among the plurality of heterogeneous networks; and
an access point selecting unit configured to
receive from a remote server reference information containing one or more reference values regarding at least one access point by transmitting a request for access point reference information through one network among the plurality of heterogeneous networks, the request including type information of the wireless communication terminal and identification information of one or more access points belonging to the wireless data network,
calculate, for each of one or more access points found from searching the wireless data network, relative strength of a signal strength of the each access point with respect to a reference value of the each access point written in the received reference information, and
determine whether to switch to the wireless data network or connection priority of the found access points, based on the calculated relative strengths.

2. The wireless communication terminal of claim 1, wherein the information reporting unit is configured to determine a particular value as the value of the first property signal strength, the particular value being a value of a smallest signal strength at which receiving speeds pertaining to upper part of a predetermined ratio or all in a distribution of receiving speeds have been provided, and the distribution consisting of receiving speeds that are equal to or above a predetermined speed among receiving speeds obtained from measuring receiving speed of the wireless communication terminal for data received through the arbitrary access point.

3. The wireless communication terminal of claim 1, wherein the value of the second property signal strength is smaller than the value of the first property signal strength, and the third value is determined according to a pre-specified method between the value of the first property signal strength and the value of the second property signal strength.

4. The wireless communication terminal of claim 3, wherein the value of the second property signal strength is a signal strength value that is detected at time of successful connection in a case that a connection process carried out for the arbitrary access point satisfies a pre-specified condition.

5.-7. (canceled)

8. The wireless communication terminal of claim 1, wherein the information reporting unit is configured to prepare the mutual communication property information by further incorporate therein information about date and time at which a signal strength value included in the mutual communication property information is obtained.

9. The wireless communication terminal of claim 1, wherein the information reporting unit is configured to further incorporate, with respect to at least one access point other than the arbitrary access point, a value of the first property signal strength or a third value determined from the value of the first property signal strength and a value of the second property signal strength in the mutual communication property information together with identification information of each of the at least one access point.

10. The wireless communication terminal of claim 1, wherein in a case that an access point to which the calculated relative strength is related uses a channel overlapping with another access point, the access point selecting unit is further configured to modify the relative strength to be decreased and use the modified relative strength in the determination of the connection priority.

11. (canceled)

12. The wireless communication terminal of claim 1, wherein the signal strength of the each access point is a signal strength detected from searching the wireless data network for access points before or after receiving the reference information.

13. The wireless communication terminal of claim 1, wherein the access point selecting unit is configured to transmit the request for access point reference information if a current state of the wireless communication terminal corresponds to a predetermined condition that includes at least one of:
a condition that locking state of the wireless communication terminal is released;
a condition that a search is to be made according to a predetermined search period;
a condition that a pre-designated application starts up;
a condition that a network access request is to be made from an arbitrary application;
a condition that a request for entering the wireless data network is made from an external server; and
a condition that higher bandwidth than a predetermined level is demanded for data to be received.

14-21. (canceled)

22. A method of a wireless communication terminal for receiving from a remote server information for connecting to a wireless data network, the method comprising:
preparing a reference information request including type information of the wireless communication terminal and identification information of one or more access points found from a search of the wireless data network for access points;
transmitting the prepared reference information request to the remote server of which address information for access is pre-assigned;
receiving from the remote server reference information which is a response to the transmitted reference information request;
calculating, for each of at least one access point found from searching the wireless data network, relative strength of a signal strength of the each access point with respect to a reference value of the each access point written in the received reference information; and
determining whether to switch connection to the wireless data network or connection priority of the found access points, based on the calculated, individual relative strengths.

23. A wireless communication terminal capable of accessing a plurality of heterogeneous networks including a wireless data network, comprising:
an information collecting unit configured to
determine a value of a first property signal strength and a value of a second property signal strength smaller than the value of the first property signal strength, based on a communication property related to an arbitrary access point of the wireless data network,
prepare a property statistical table to reflect the determined values and identification information of the arbitrary access point, and
determine, for each of at least one access point found from searching the wireless data network, a reference value from target statistical elements registered with respect to the each access point in the property statistical table; and
an access point selecting unit configured to
calculate, for each of the at least one access point, relative strength of a signal strength of the each access point with respect to the reference value determined by the information collecting unit for the each access point, and
determine whether to switch connection from a currently connected wireless communication network to the wireless data network or connection priority of each of the at least one access point, based on the calculated relative strengths,
wherein in preparing the property statistical table to reflect the determined two values, the information collecting unit registers the two values in the property statistical table or registers a value, between the two values, obtained by applying the two values to a pre-specified rule.

24.-28. (canceled)

29. The wireless communication terminal of claim 23, wherein the information collecting unit is configured to:
determine a first particular value as the value of the first property signal strength, the first particular being a value of a smallest signal strength at which receiving speeds pertaining to upper part of a predetermined ratio or all in a distribution of receiving speeds have been provided, and the distribution consisting of receiving speeds that are equal to or above a predetermined speed among receiving speeds obtained from measuring data receiving speed of the wireless communication terminal for data received through the arbitrary access point; and
determine a second particular value to the value of the second property signal strength, the second particular value being a value of a highest signal strength at which all or a part of receiving speeds, which are equal to or below a predetermined speed among receiving speeds obtained from measuring data receiving speed of the wireless communication terminal for data received through the arbitrary access point and are also equal to or below a particular speed for receiving a data object requested by an arbitrary executable entity of the wireless communication terminal, have been provided.

30. (canceled)

31. An apparatus for providing programs stored in a storage, comprising:
communication means being capable of transceiving data through communication with an outside entity; and
storing means storing an application to be run on a wireless communication terminal, the application being transmitted or received through the communication means,
wherein the application includes program codes to accomplish functions, in case of being run on the wireless communication terminal, that comprise:
determining a value of a first property signal strength based on data receiving speed during usage of a data service through an access point of a wireless data network;
preparing mutual communication property information including at least the determined value or at least a third value determined from the determined value and a value of a second property signal strength, the mutual communication property information further including identification information of the access point and type information of the wireless communication terminal;
reporting the mutual communication property information to a remote server through one network among a plurality of heterogeneous networks;
receiving from a remote server reference information containing one or more reference values regarding at least one access point by transmitting a request for access point reference information through one network among the plurality of heterogeneous networks, the request including type information of the wireless communication terminal and identification information of one or more access points belonging to the wireless data network;
calculating, for each of one or more access points found from searching the wireless data network, relative strength of a signal strength of the each access point with respect to a reference value of the each access point written in the received reference information; and
determining whether to switch to the wireless data network or connection priority of the found access points, based on the calculated relative strengths.

32. (canceled)

33. A method for providing a wireless communication terminal with information for connecting to a wireless data network, comprising:
causing a property statistical table to reflect received mutual communication property information, the mutual communication property information including, for at least one access point, a value of signal strength determined from property revealed in communicating with each of the at least one access point, identification information of each of the at least one access point, and type information of a wireless communication terminal;
obtaining a reference value from target statistical elements registered in the property statistical table, for each of one or more access points, if receiving from a particular wireless communication terminal a request of access point reference information in which access point identification information is specified for said one or more access points and type information of the particular wireless communication terminal is included, the target statistical elements being related to the each access point and the type information of the particular wireless communication terminal; and
preparing reference information by incorporating therein the reference value obtained for each of said one or more access points and transmitting the prepared reference information to the particular wireless communication,
wherein the obtained reference value is to be used as a basis when a relative strength of signal strength of a corresponding access point is calculated by the particular wireless communication.

34.-50. (canceled)

51. The method of claim 33, wherein the value of signal strength is a value of a first property signal strength determined based on a data receiving speed provided by a corresponding access point through which a wireless communication terminal uses data service, and
the obtained reference value is smaller than an average of values of the first property signal strength belonging to the target statistical elements.

52. The method of claim 51, wherein the mutual communication property information further includes, for at least one access point, a value of a second property signal strength smaller than the value of the first signal strength, and
the obtaining the reference value comprises:
determining a first representative value from values of the first property signal strength belonging to the target statistical elements and a second representative value from values of the second property signal strength belonging to the target statistical elements; and
deciding the reference value between the two representative values based on the first and second representative values.

53. The method of claim 51, wherein the causing the property statistical table to reflect the mutual communication property information comprises:
obtaining, based on a signal strength value different from the value of the first property signal strength, a value of a third property signal strength that is between the signal strength value and the value of the first property signal strength; and
causing the property statistical table to reflect the obtained value of the third property signal strength instead of the value of the first property signal strength, and
wherein the obtaining the reference value obtains the reference value from a representative value determined from values of the third property signal strength belonging to the target statistical elements.

54. The method of claim 33, wherein the causing the property statistical table to reflect the mutual communication property information comprises:
determining one classifying item among predetermined classifying items based on date and time at which the value of signal strength is obtained or at which the mutual communication property information is received; and
causing the property statistical table to reflect the mutual communication property information in such a way that the mutual communication property information is classified into the property statistical table by the determined classifying item, and
wherein the obtaining the reference value comprises:
determining one classifying item among predetermined classifying items based on date and time at which the request of access point reference information is received; and
obtaining the reference value from statistical elements belonging to the determined classifying item among the target statistical elements.

55. The method of claim 33, wherein the obtaining the reference value further obtains, for at least one additional access point besides said one or more access points specified in the request, the reference value from target statistical elements for the at least one additional access point and type information of the particular wireless communication terminal, and
wherein the preparing the reference information further incorporates identification information of the additional access point and the reference value obtained for the additional access point into the reference information.

56. The method of claim 33, wherein the value of signal strength is a value calculated from two signal strength values that are determined by a wireless communication terminal based on property revealed in communicating with a corresponding access point, and
the obtained reference value is a representative value determined from the target statistical elements.

57. The method of claim 56, wherein the two signal strength values are a first signal strength value, determined based on receiving speeds equal to or above a predetermined speed among data receiving speeds provided in using data service by each of the at least one access point, and a second signal strength value, smaller than the first signal strength value, determined based on receiving speeds equal to or below a predetermined speed among data receiving speeds provided in using data service by the each access point, and the value of signal strength is a value, calculated from the two signal strength values, between the first and second signal strength values.

58. The method of claim 56, wherein the two signal strength values are a first signal strength value, determined based on receiving speeds equal to or above a predetermined speed among data receiving speeds provided in using data service by each of the at least one access point, and a second signal strength value, smaller than the first signal strength value, detected in a successful connection process to the each access point, and the value of signal strength is a value, calculated from the two signal strength values, between the first and second signal strength values.

59. The method of claim 56, wherein the causing the property statistical table to reflect the mutual communication property information, if another received mutual communication property information contains an arbitrary signal strength value which is different in property from the signal strength value, further comprises:
determining a single value between the arbitrary signal strength value and a third value based on the arbitrary signal strength value and the third value; and
causing the property statistical table to reflect the another mutual communication property information in after replacing the arbitrary signal strength value contained in the another mutual communication property information with the determined single value,
wherein the arbitrary signal strength value of different property is a signal strength value determined based on a data receiving speed provided in using data service by an access point, and the third value is a value pre-assigned for type information of a wireless communication terminal and a corresponding access point that are contained in the another received mutual communication property information.
